(19) United States
(12) Patent Application Publication
(10) Pub. No.: US 2023/0019934 A1
(43) Pub. Date: Jan. 19, 2023

(54) PRESENTATION CONTROL APPARATUS

(71) Applicant: DENSO CORPORATION, Kariya-city (JP)

(72) Inventors: Takuya KUME, Kariya-city (JP); Yuuta MATSUMOTO, Kariya-city (JP); Kunihiko CHIBA, Kariya-city (JP); Kazuki KOJIMA, Kariya-city (JP); Shiori MANEYAMA, Kariya-city (JP)

(21) Appl. No.: 17/954,550

(22) Filed: Sep. 28, 2022

Related U.S. Application Data
(63) Continuation of application No. PCT/JP2021/010652, filed on Mar. 16, 2021.

(30) Foreign Application Priority Data
Mar. 31, 2020 (JP) 2020-062634
Feb. 4, 2021 (JP) 2021-016687

(51) Int. Cl. B60W 60/00; B60W 50/14; B60W 40/08

(52) U.S. Cl. CPC B60W 60/0053; B60W 50/14; B60W 40/08; B60W 2050/146

(57) ABSTRACT

A presentation control apparatus is configured to control information presentation to a driver of a vehicle capable of performing automated driving. The presentation control apparatus includes a judging section and a presentation control section. The judging section is configured to distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited. The presentation control section is configured to present first transition information related to a transition from the automated driving prohibited state to the particular action permitted state in an emphasized form compared to second transition information related to a transition from the particular action prohibited state to the particular action permitted state.

### CROSS REFERENCE TO RELATED APPLICATION

The present application is a continuation application of International Patent Application No. PCT/JP2021/010652 filed on Mar. 16, 2021, which designated the U.S. and claims the benefit of priority from Japanese Patent Application No. 2020-062634 filed on Mar. 31, 2020, and Japanese Patent Application No. 2021-016687 filed on Feb. 4, 2021. The entire disclosures of all of the above applications are incorporated herein by reference.

### TECHNICAL FIELD

The disclosure in this specification relates to a technology of controlling presentation of information to a driver of a vehicle capable of executing automated driving.

### BACKGROUND

A technology of switching from manual driving to automated driving is known.

### SUMMARY

A first aspect of the present disclosure is a presentation control apparatus configured to control information presentation to a driver of a vehicle capable of performing automated driving. The presentation control apparatus includes: a judging section configured to distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited; and a presentation control section configured to present first transition information related to a transition from the automated driving prohibited state to the particular action permitted state in an emphasized form compared to second transition information related to a transition from the particular action prohibited state to the particular action permitted state.

A second aspect of the present disclosure is a presentation control apparatus configured to control information presentation to a driver of a vehicle capable of performing automated driving. The presentation control apparatus includes: a judging section configured to distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited; and a presentation control section configured to present second transition information related to a transition from the particular action prohibited state to the particular action permitted state in an emphasized form compared to first transition information related to a transition from the automated driving prohibited state to the particular action permitted state.

A third aspect of the present disclosure is a presentation control apparatus configured to control information presentation to a driver of a vehicle capable of performing automated driving. The presentation control apparatus includes: a judging section configured to distinguish between a particular action permitted state where the driver is permitted to take a particular action other than driving during the automated driving and a particular action prohibited state where the driver is prohibited to take the particular action during the automated driving; and a presentation control section configured to present prohibited transition information related to a transition from the particular action permitted state to the particular action prohibited state in an emphasized form compared to permitted transition information related to a transition from the particular action prohibited state to the particular action permitted state.

A fourth aspect of the present disclosure is a presentation control apparatus configured to control information presentation to a driver of a vehicle capable of performing automated driving. The presentation control apparatus includes: a judging section configured to distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited; a lane identifying section configured to identify a type of a lane in which the vehicle is traveling, and a presentation control section configured to present first information related to a transition from the automated driving prohibited state to the particular action permitted state and second information related to a transition from the particular action prohibited state to the particular action permitted state. The presentation control section is configured to change an emphasized degree of a presentation form of the first transition information and the second transition information depending on the type of the lane.

A fifth aspect of the present disclosure is a computer program product configured to control information presentation to a driver of a vehicle capable of performing automated driving, the computer program product being stored on a non-transitory computer readable medium and including instructions configured to, when executed by at least one processor, cause the at least one processor to: distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited; and present first transition information related to a transition from the automated driving prohibited state to the particular action permitted state in an emphasized form compared to second transition information related to a transition from the particular action prohibited state to the particular action permitted state.

A sixth aspect of the present disclosure is a computer program product configured to control information presentation to a driver of a vehicle capable of performing automated driving, the computer program product being stored on a non-transitory computer readable medium and including instructions configured to, when executed by at least one processor, cause the at least one processor to: distinguish between a particular action permitted state where the driver is permitted to take a particular action other than driving during the automated driving and a particular action prohibited state where the driver is prohibited to take the particular action during the automated driving; and present prohibited transition information related to a transition from the particular action permitted state to the particular action prohibited state in an emphasized form compared to permitted transition information related to a transition from the particular action prohibited state to the particular action permitted state.

A seventh aspect of the present disclosure is a computer program product configured to control information presentation to a driver of a vehicle capable of performing automated driving, the computer program product being stored on a non-transitory computer readable medium and including instructions configured to, when executed by at least one processor, cause the at least one processor to: distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited; and present second transition information related to a transition from the particular action prohibited state to the particular action permitted state in an emphasized form compared to first transition information related to a transition from the automated driving prohibited state to the particular action permitted state.

An eighth aspect of the present disclosure is a computer program product configured to control information presentation to a driver of a vehicle capable of performing automated driving, the computer program product being stored on a non-transitory computer readable medium and including instructions configured to, when executed by at least one processor, cause the at least one processor to: distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited; identify a type of a lane in which the vehicle is traveling; present first information related to a transition from the automated driving prohibited state to the particular action permitted state and second information related to a transition from the particular action prohibited state to the particular action permitted state; and change an emphasized degree of a presentation form of the first transition information and the second transition information depending on the type of the lane.

### BRIEF DESCRIPTION OF THE DRAWINGS

FIG. 1 is a figure depicting a system including an HCU.

FIG. 2 is a block diagram depicting an example of functionalities of the HCU.

FIG. 3 is a figure depicting the interior of a vehicle.

FIG. 4 is a time chart depicting an example of notification executed at each display device.

FIG. 5 is a figure depicting an example of information presentation.

FIG. 6 is a figure depicting an example of information presentation.

FIG. 7 is a figure depicting an example of information presentation.

FIG. 8 is a figure depicting an example of information presentation.

FIG. 9 is a figure depicting an example of information presentation.

FIG. 10 is a figure depicting an example of information presentation.

FIG. 11 is a figure depicting an example of information presentation.

FIG. 12 is a figure depicting an example of information presentation.

FIG. 13 is a figure depicting an example of information presentation.

FIG. 14 is a figure depicting an example of information presentation.

FIG. 15 is a figure depicting an example of information presentation.

FIG. 16 is a figure depicting an example of information presentation.

FIG. 17 is a figure depicting an example of information presentation.

FIG. 18 is a figure depicting an example of information presentation.

FIG. 19 is a flowchart depicting an example of a presentation control method executed by the HCU.

FIG. 20 is a flowchart depicting an example of the presentation control method executed by the HCU.

FIG. 21 is a flowchart depicting an example of the presentation control method executed by the HCU.

FIG. 22 is a flowchart depicting an example of the presentation control method executed by the HCU.

FIG. 23 is a flowchart depicting an example of the presentation control method executed by the HCU.

FIG. 24 is a flowchart depicting an example of the presentation control method executed by the HCU.

FIG. 25 is a flowchart depicting an example of the presentation control method executed by the HCU in a second embodiment.

FIG. 26 is a flowchart depicting an example of the presentation control method executed by the HCU in a third embodiment.

FIG. 27 is a flowchart depicting an example of the presentation control method executed by the HCU in a fifth embodiment.

FIG. 28 is a flowchart depicting an example of the presentation control method executed by the HCU in a sixth embodiment.

FIG. 29 is a flowchart depicting an example of the presentation control method executed by the HCU in a seventh embodiment.

FIG. 30 is a flowchart depicting an example of the presentation control method executed by the HCU in an eighth embodiment.

FIG. 31 is a flowchart depicting an example of the presentation control method executed by the HCU in the eighth embodiment.

FIG. 32 is a flowchart depicting an example of the presentation control method executed by the HCU in a ninth embodiment.

FIG. 33 is a flowchart depicting an example of the presentation control method executed by the HCU in the ninth embodiment.

FIG. 34 is a flowchart depicting subsequent processes of the flowchart in FIG. 33.

### EMBODIMENTS

There is now a possibility that, in accordance with the control content of automated driving, for example, situations where drivers are permitted to perform particular actions other than driving called second tasks, and situations where the drivers are prohibited to perform the particular actions occur.

### First Embodiment

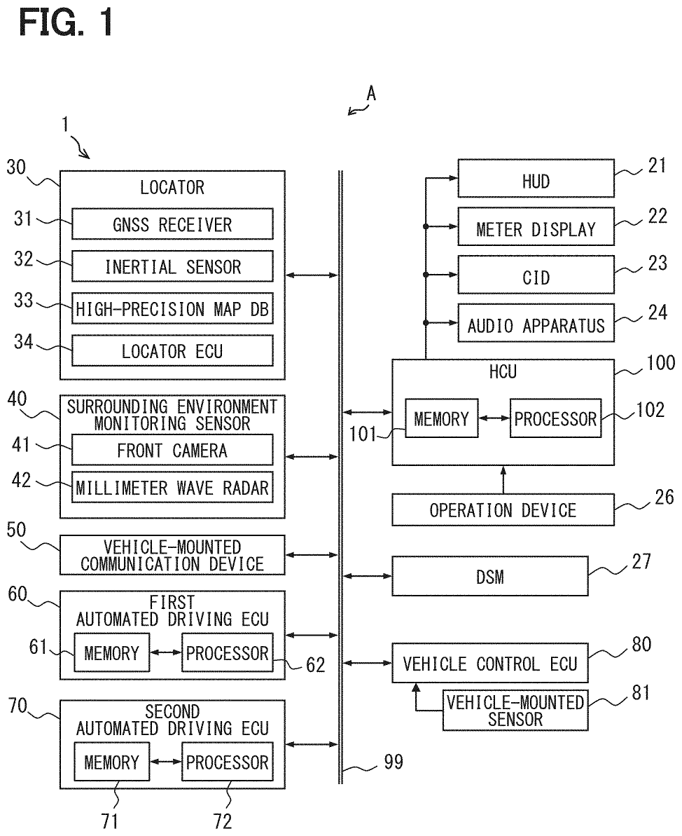

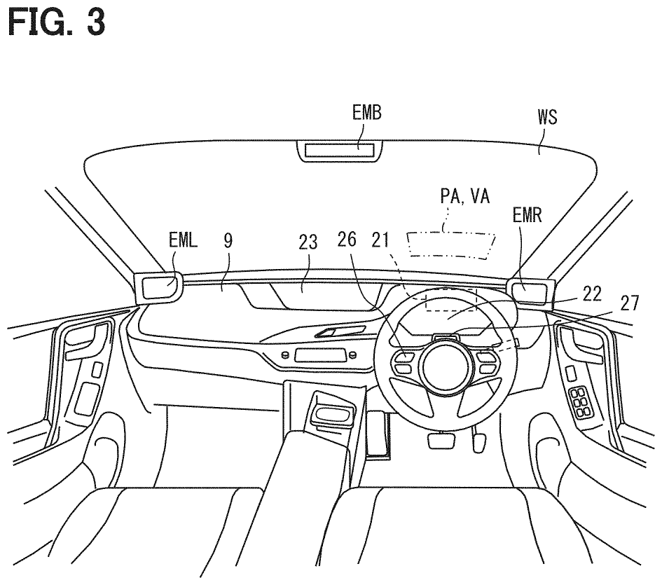

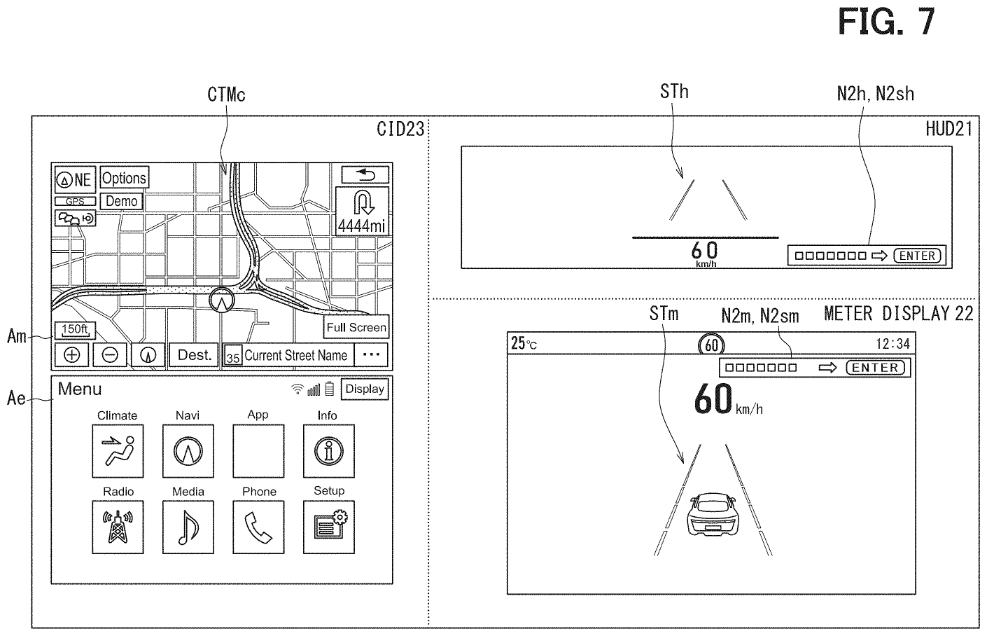

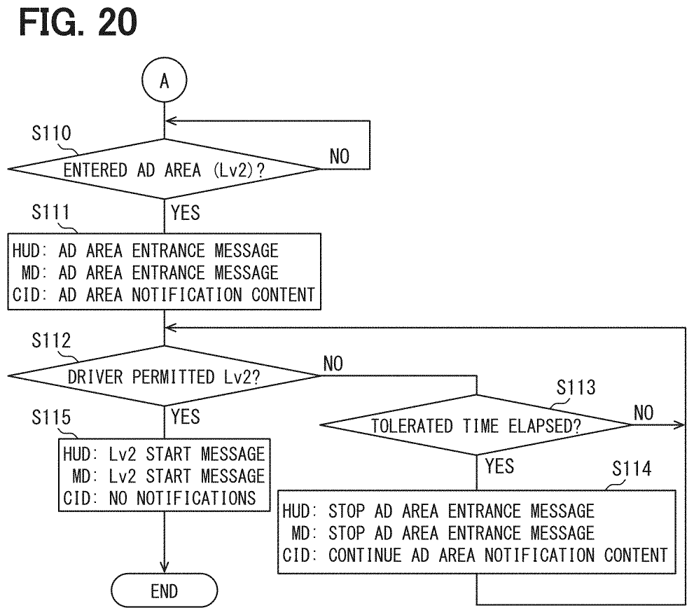

A presentation control apparatus according to a first embodiment is explained with reference to FIG. 1 to FIG. 24. The presentation control apparatus according to the first embodiment is provided by an HCU (Human Machine Interface Control Unit) 100 mounted on a vehicle A. Together with a plurality of display devices, an audio apparatus 24, an operation device 26 and the like, the HCU 100 is included in an HMI (Human Machine Interface) system used in the vehicle A. The HMI system has an input interface functionality of being operated by an occupant (e.g. a driver, etc.) of the vehicle A, and an output interface functionality of presenting information to the driver. The HCU 100 is connected with a locator 30, a surrounding environment monitoring sensor 40, a vehicle-mounted communication device 50, a first automated driving ECU 60, a second automated driving ECU 70, a DSM 27 and a vehicle control ECU 80 via a communication bus 99 or the like.

The locator 30 generates user's vehicle position information and the like by combined positional measurement using a combination of a plurality of pieces of acquired information. The locator 30 includes a GNSS (Global Navigation Satellite System) receiver 31, an inertia sensor 32, a map database (hereinafter, “map DB”) DB 33 and a locator ECU 34. The GNSS receiver 31 receives positioning signals from a plurality of positional measurement satellites. The inertia sensor 32 is a sensor that senses inertial force acting on the vehicle A. For example, the inertia sensor 32 includes a gyro sensor and an acceleration sensor.

The map DB 33 is a non-volatile memory, and has loaded thereonto map data such as link data, node data, road geometries or structures. The map data may be a three-dimensional map including a point cloud of feature points of road geometries and structures. Note that the three-dimensional map may be one that is generated on the basis of captured images by REM (Road Experience Management). In addition, the map data may also include traffic regulation information, road engineering work information, weather information, traffic light information and the like. The map data loaded onto the map DB is updated regularly or at any time on the basis of latest information received at the vehicle-mounted communication device 50 mentioned later.

The locator ECU 34 is a configuration including, as its main constituent, a microcomputer including a processor, a memory, an input/output interface and a bus or the like connecting them. The locator ECU 34 combines positioning signals received at the GNSS receiver 31, the map data in the map DB 33 and measurement results of the inertia sensor 32 to thereby serially measure the position (hereinafter, the user's vehicle position) of the vehicle A. For example, the user's vehicle position may be represented by latitude/longitude coordinates. Note that for the positional measurement of the user's vehicle position, a travelled distance determined from signals serially output from a vehicle speed sensor mounted on the vehicle A may be used. In a case that the three-dimensional map including a point cloud of feature points of road geometries and structures is used as the map data, the locator ECU 34 may not use the GNSS receiver 31, but may use the three-dimensional map and sensing results of the surrounding environment monitoring sensor 40 to identify the user's vehicle position.

The surrounding environment monitoring sensor 40 is an autonomous sensor that monitors the surrounding environment of the vehicle A. The surrounding environment monitoring sensor 40 can sense, in a sensing range around the vehicle A, moving objects such as pedestrians, cyclists, non-human animals or non-user's vehicles, furthermore stationary objects such as fallen objects on roads, guardrails, curb stones, traffic signs, markings on road surfaces such as lane markings or roadside structures and the like. The surrounding environment monitoring sensor 40 provides sensing information obtained by sensing objects around the vehicle A to the first automated driving ECU 60, the second automated driving ECU 70 and the like through the communication bus 99.

As sensing configurations for sensing objects, the surrounding environment monitoring sensor 40 has a front camera 41 and a millimeter wave radar 42. The front camera 41 outputs, as sensing information, at least either of image captured data obtained by capturing images of areas in front of the vehicle A, and results of analysis of the image captured data. For example, the millimeter wave radar 42 includes a plurality of radars that are arranged at intervals from each other on each of the front and rear bumpers of the vehicle A. The millimeter wave radar 42 emits millimeter waves or submillimeter waves to areas in front of the vehicle A, side areas in front of the vehicle A, areas behind the vehicle A, side areas behind the vehicle A and the like. The millimeter wave radar 42 generates sensing information by a process of receiving reflected waves reflected off moving objects, stationary objects and the like. Note that other sensing configurations such as a LiDAR (Light Detection and Ranging/Laser Imaging Detection and Ranging) that senses a point cloud of feature points of geographical features or a sonar that receives reflected waves of ultrasonic waves may be included in the surrounding environment monitoring sensor 40.

The vehicle-mounted communication device 50 is a communication module mounted on the vehicle A. The vehicle-mounted communication device 50 at least has a V2N (Vehicle to cellular Network) communication functionality according to communication standards such as LTE (Long Term Evolution) or 5G, and transmits and receives radio waves with base stations around the vehicle A. The vehicle-mounted communication device 50 may further have a vehicle to roadside infrastructure (Vehicle to roadside Infrastructure; “V2I” hereinbelow) communication, vehicle to vehicle (Vehicle to Vehicle; “V2V” hereinbelow) or other communication functionalities. By V2N communication, the vehicle-mounted communication device 50 enables cooperation (Cloud to Car) between a cloud and a vehicle-mounted system. By having the vehicle-mounted communication device 50 mounted thereon, the vehicle A becomes a connected car that can be connected to the Internet. The vehicle-mounted communication device 50 acquires congestion information distributed from a traffic information center or the like, and provides the congestion information to the second automated driving ECU 70, the HCU 100 and the like.

The first automated driving ECU 60 and the second automated driving ECU 70 are configurations including, as their main constituents, computers including processors 62 and 72, memories 61 and 71, input/output interfaces and buses or the like connecting them, respectively. The first automated driving ECU 60 and the second automated driving ECU 70 are ECUs that can execute automated travelling control of controlling travelling of the vehicle A partially or substantially entirely.

The first automated driving ECU 60 has a partial automated driving functionality of taking over driving operation of a driver partially. The second automated driving ECU 70 has an automated driving functionality of being able to take over driving operation of the driver. As an example, the first automated driving ECU 60 enables partial automated travelling control (advanced driving assistance) of Level 2 or lower in automated driving levels defined by the Society of Automotive Engineers. That is, the first automated driving ECU 60 enables implementation of automated travelling control that requires a driver to perform surrounding environment monitoring. Stated differently, the first automated driving ECU 60 enables implementation of automated driving in which second tasks mentioned later are prohibited.

For example, the first automated driving ECU 60 can execute one or both of control in the longitudinal direction and control in the lateral direction of the vehicle A. Here, the longitudinal direction is a direction that coincides with the forward/backward direction of the vehicle A, and the lateral direction is a direction that coincides with the widthwise direction of the vehicle A. The first automated driving ECU 60 executes control of acceleration/deceleration of the vehicle A as the control in the longitudinal direction. In addition, the first automated driving ECU 60 executes steering angle control of the steering wheel of the vehicle A as the control in the lateral direction.

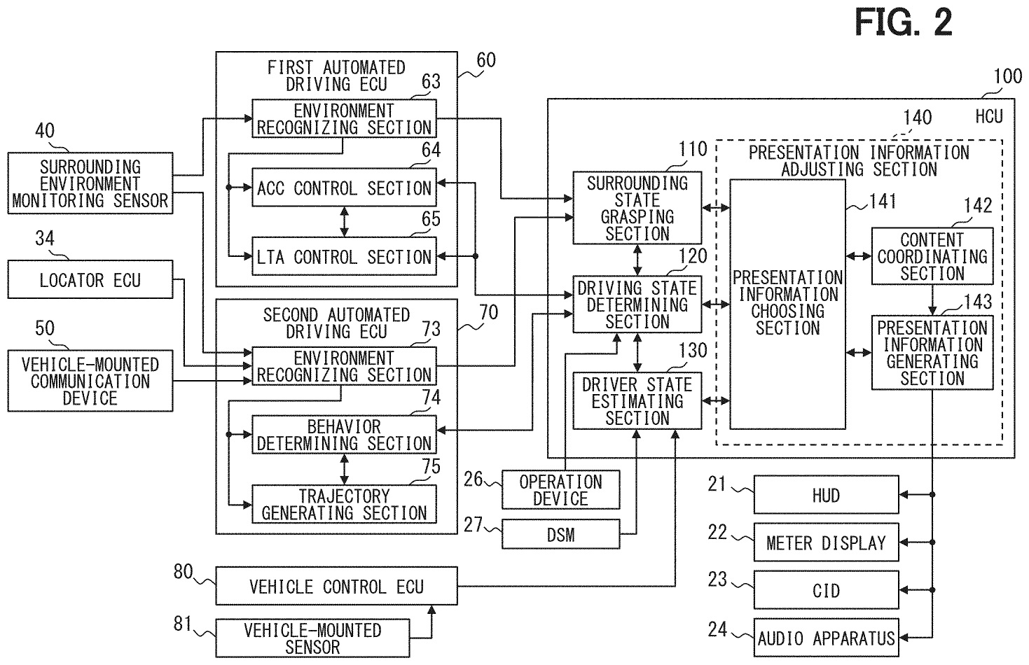

By a driving assistance program stored on the memory 61 causing the processor 62 to execute a plurality of commands, the first automated driving ECU 60 constructs a plurality of functional sections that realize the advanced driving assistance mentioned above. Specifically, as depicted in FIG. 2, the first automated driving ECU 60 constructs an environment recognizing section 63, an ACC control section 64, an LTA control section 65 and the like as functional sections.

The environment recognizing section 63 recognizes the travelling environment around the vehicle A on the basis of sensing information acquired from the surrounding environment monitoring sensor 40. The environment recognizing section 63 provides, to the ACC control section 64 and the LTA control section 65 and as sensing information having undergone analysis, results of sensing information analysis implemented for recognition of the travelling environment. As an example, as the sensing information having undergone analysis, the environment recognizing section 63 generates information (lane information) representing relative positions and shapes of left and right markings or road ends of a lane where the vehicle A is currently travelling (hereinafter, a current lane). Additionally, as the sensing information having undergone analysis, the environment recognizing section 63 generates information (preceding vehicle information) representing whether or not there is a preceding vehicle preceding the vehicle A on the current lane, and the position and speed of a preceding vehicle in a case that there is a preceding vehicle. The environment recognizing section 63 serially provides the preceding vehicle information to the ACC control section 64, and serially provides the lane information to the LTA control section 65. Note that the environment recognizing section 63 may be configured to recognize MD areas, AD area, ST segments and non-ST segments mentioned later.

On the basis of the preceding vehicle information, the ACC control section 64 executes ACC (Adaptive Cruise Control) control of realizing constant-speed travelling of the vehicle A at a target speed or travelling to follow a preceding vehicle. On the basis of the lane information, the LTA control section 65 executes LTA (Lane Tracing Assist) control of maintaining in-lane travelling of the vehicle A. Specifically, the control sections 64 and 65 generate control orders for acceleration/deceleration or steering angles, and serially provides the control orders to the vehicle control ECU 80 mentioned later. The ACC control is an example of the control in the longitudinal direction, and the LTA control is an example of the control in the lateral direction.

The first automated driving ECU 60 realizes Level 2 automated driving by executing both the ACC control and the LTA control. Note that the first automated driving ECU 60 may be able to realize Level 1 automated driving by executing either one of the ACC control and the LTA control.

On the other hand, the second automated driving ECU 70 enables automated travelling control of Level 3 or higher in the automated driving levels mentioned above. That is, the second automated driving ECU 70 makes it possible to implement automated driving in which a driver is permitted to suspend surrounding environment monitoring. Stated differently, the second automated driving ECU 70 makes it possible to implement automated driving in which the driver is permitted to perform second tasks.

Here, the second tasks are non-driving actions that the driver is permitted to perform, and are predefined particular actions. During an automated travelling period in which the vehicle A performs automated travelling by using a Level 3 automated driving functionality of the second automated driving ECU 70, the driver in this case is a person (passenger) who is to take over the control of driving from the automated driving system when the vehicle A exits a limited area or at a time of emergency. Until a request to implement driving operation, that is, a request to take over driving (Take Over Request), is made by the automated driving system, the driver can be legally permitted to implement the second tasks.

Second tasks can be called secondary activities, other activities or the like. It is supposed that second tasks are not allowed to hinder the driver from dealing with a request to take over driving operation from the automated driving system. As an example, it can be expected that second tasks are actions such as viewing and listening of the contents of moving images or the like, operation of smartphones or the like, reading or eating.

By an automated driving program stored on the memory 71 causing the processor 72 to execute a plurality of commands, the second automated driving ECU 70 constructs a plurality of functional sections that realize the automated driving mentioned above. Specifically, the second automated driving ECU 70 constructs an environment recognizing section 73, a behavior determining section 74, a trajectory generating section 75 and the like as functional sections.

The environment recognizing section 73 recognize the travelling environment around the vehicle A on the basis of the sensing information acquired from the surrounding environment monitoring sensor 40, the user's vehicle position and map data acquired from the locator ECU 34, communication information acquired from the vehicle-mounted communication device 50 and the like. As an example, the environment recognizing section 73 recognizes the position of the current lane of the vehicle A, the shape of the current lane, relative positions and relative speeds of moving objects around the vehicle A and the like. The environment recognizing section 73 serially provides these recognition results to the behavior determining section 74 and the trajectory generating section 75.

Additionally, the environment recognizing section 73 judges a manual driving area (MD area) and an automated driving area (AD area) in a travelling region of the vehicle A, and judges an ST segment and a non-ST segment in the AD area, and serially provides the recognition results to the HCU 100.

MD areas are areas where automated driving is prohibited. Stated differently, MD areas are areas where it is defined that a driver executes all of the control in the longitudinal direction, control in the lateral direction and surrounding environment monitoring of the vehicle A. For example, MD areas are areas with roads which are local roads.

AD areas are areas where automated driving is permitted. Stated differently, AD areas are areas where the vehicle A can take over at least one of the control in the longitudinal direction, control in the lateral direction and surrounding environment monitoring. For example, AD areas are areas with roads which are freeways or roads dedicated for automobiles.

An AD area can be divided into a non-ST segment where automated driving of Level 2 or lower is available and an ST segment where automated driving of Level 3 or higher is available. Note that a non-ST segment where Level 1 automated driving is permitted and a non-ST segment where Level 2 automated driving is permitted are equivalent to each other in the first embodiment.

For example, ST segments are congested travelling segments (congested segments). In addition, for example, ST segments are travelling segments for which a high-precision map has been created. A surrounding state grasping section 110 determines that a segment is an ST segment when a state where the travelling speed of the vehicle A is within a threshold range has continued for a predetermined period. Alternatively, the surrounding state grasping section 110 may determine whether or not a segment is an ST segment by taking into consideration a combination of the user's vehicle position and the congestion information acquired from the vehicle-mounted communication device 50. Note that the surrounding state grasping section 110 may determine that, in addition to a congested segment, a segment where a particular condition other than congestion is satisfied regarding the surrounding environment of the vehicle A is an ST segment.

The behavior determining section 74 determines planned future behavior of the vehicle A on the basis of travelling environment recognition results. Specifically, in a case that an instruction for starting automated driving has been acquired by coordinated operation with the HCU 100 mentioned later, the behavior determining section 74 decides, as future behavior, a pattern of behavior that the vehicle A should exhibit in order to arrive at a destination. For example, the pattern includes driving straight, right turns, left turns, lane changes and the like. In addition, in a case that it is determined that transfer of the driving control to the driver is necessary, the behavior determining section 74 generates a take over request, and provides the take over request to the HCU 100.

On the basis of the travelling environment recognition results and the decided future behavior, the trajectory generating section 75 generates a travelling trajectory of the vehicle A in a segment where automated driving can be executed. For example, the travelling trajectory includes target positions of the vehicle A as it advances, target speeds at the target positions and the like. The trajectory generating section 75 serially provides the generated travelling trajectory to the vehicle control ECU 80 as control orders that the vehicle A follows in automated travelling.

The automated driving system including these automated driving ECUs 60 and 70 makes it possible to execute at least automated driving equivalent to Level 2 and Level 3 of the vehicle A. Hereinbelow, a state where automated driving equivalent to Level 2 is being executed is written as a “Level 2 execution mode,” and a state where automated driving equivalent to Level 3 is being executed is written as a “Level 3 execution mode,” in some cases.

The vehicle control ECU 80 is an electronic control unit that performs acceleration/deceleration control and steering control of the vehicle A. The vehicle control ECU 80 includes a steering ECU that performs the steering control, a power unit control ECU and a brake ECU that perform the acceleration/deceleration control and the like. The vehicle control ECU 80 acquires sensing signals output from sensors such as a steering angle sensor or a vehicle speed sensor mounted on the vehicle A, and outputs control signals to travelling control devices such as an electronic control throttle, a brake actuator or an EPS (Electric Power Steering) motor. By acquiring control instructions for the vehicle A from the first automated driving ECU 60 or the second automated driving ECU 70, the vehicle control ECU 80 controls each travelling control device such that automated travelling following the control instructions is realized.

In addition, the vehicle control ECU 80 is connected with a vehicle-mounted sensor 81 that senses driving operation information of driving members operated by the driver. For example, the vehicle-mounted sensor 81 includes a pedal sensor that senses the step-on amount of an accelerator pedal, a steering sensor that senses the steering amount of the steering wheel and the like. The vehicle control ECU 80 serially provides the sensed driving operation information to the HCU 100.

The DSM 27 is a configuration including a near infrared light source and a near infrared camera, and a control unit that controls these. For example, the DSM 27 is installed on the top surface of a steering column section, the top surface of an instrument panel 9 or the like in such a posture that the near infrared camera faces the head restraint portion of the driver's seat. By using the near infrared camera, the DSM 27 captures images of the head of the driver irradiated with near infrared light by the near infrared light source. The images captured by the near infrared camera undergo image analysis by the control unit. From the captured images, the control unit extracts information such as the positions of the eye points of the driver or the line-of-sight direction, and provides the extracted driver state information to the HCU 100 and the like through the communication bus 99.

Next, details of each of the plurality of display devices, the audio apparatus 24, the operation device 26 and the HCU 100 included in the HMI system are explained.

The plurality of display devices include a head-up display (hereinafter, an HUD) 21, a meter display 22, a center information display (hereinafter, a CID 23) and the like. The plurality of display devices may further include displays EMB, EML and EMR in an electronic mirror system. The HUD 21, the meter display 22 and the CID 23 are displays that present image contents such as still images or moving images as visual information to the driver.

On the basis of control signals and video data acquired from the HCU 100, the HUD 21 projects light of images to be formed in front of the driver onto a projection area PA defined on a windshield WS or the like. Light of the images reflected off the windshield WS inward to the interior of the vehicle is perceived by the driver who is seated on the driver's seat. In this manner, the HUD 21 causes virtual images to be displayed in a space in front of the projection area PA. The driver visually recognizes the virtual images in an angle of view VA displayed by the HUD 21 as images superimposed on the foreground of the vehicle A.

For example, the meter display 22 and the CID 23 are configurations including, as their main constituent, a liquid crystal display, an OLED (Organic Light Emitting Diode) display or the like. The meter display 22 and the CID 23 cause various images to be displayed on display screens on the basis of control signals and video data acquired from the HCU 100. For example, the meter display 22 is installed right in front of the driver's seat. The CID 23 is provided in front of the driver and in a middle area in the vehicle-width direction. For example, the CID 23 is installed above a center cluster in the instrument panel 9. The CID 23 has a touch panel functionality, and, for example, senses touch operation, swipe operate and the like on its display screen by the driver or the like. The CID 23 is an example of a “middle display.”

The audio apparatus 24 has a plurality of speakers installed in the interior of the vehicle. On the basis of control signals and sound/voice data acquired from the HCU 100, the audio apparatus 24 presents notification sounds, sound/voice messages or the like as auditory information to the driver. That is, the audio apparatus 24 is an information presentation device that can present information in a mode different from visual information. The auditory information is an example of “information in a particular mode different from visual information.”

The operation device 26 is an input section that receives a user apparatus input by the driver or the like. For example, the operation device 26 receives input of user operation or the like related to a start and stop of each level of automated driving functionalities. For example, the operation device 26 includes a steering switch provided to a spoke section of the steering wheel, an operation lever provided to the steering column section, a sound/voice input apparatus that recognizes utterance contents of the driver and the like.

On the basis of information from the first automated driving ECU 60, the second automated driving ECU 70 and the like mentioned above, the HCU 100 controls information presentation to the driver. The HCU 100 is a configuration including, as its main constituents, a computer including a memory 101, a processor 102, an input/output interface and a bus or the like connecting them. The processor 102 is hardware for computation processes. For example, the processor 102 includes, as a core, at least one type which is selected from a CPU (Central Processing Unit), a GPU (Graphics Processing Unit), an RISC (Reduced Instruction Set Computer)-CPU and the like.

The memory 101 is a non-transitory tangible storage medium (non-transitory tangible storage medium) onto or on which computer-readable programs, data and the like are non-transitorily loaded or stored, and which is, for example, at least one type which is selected from a semiconductor memory, a magnetic medium, an optical medium and the like. The memory 101 has loaded thereonto various programs to be executed by the processor 102 such as a presentation control program mentioned later.

The processor 102 executes a plurality of commands included in the presentation control program loaded onto the memory 101. Thereby, the HCU 100 constructs a plurality of functional sections for control for presentation to the driver. In this manner, by the presentation control program loaded onto the memory 101 causing the processor 102 to execute the plurality of commands, the plurality of functional sections are constructed in the HCU 100. Specifically, in the HCU 100, functional sections such as the surrounding state grasping section 110, a driving state determining section 120, a driver state estimating section 130 and a presentation information adjusting section 140 are constructed as depicted in FIG. 2.

The surrounding state grasping section 110 acquires travelling environment recognition results from the environment recognizing section 63 of the first automated driving ECU 60 or the environment recognizing section 73 of the second automated driving ECU 70. The surrounding state grasping section 110 grasps the surrounding state of the vehicle A on the basis of the acquired recognition results. Specifically, the surrounding state grasping section 110 grasps that the vehicle A is approaching an AD area, entering an AD area, approaching an ST segment, entering an ST segment, and so on. The surrounding state grasping section 110 serially provides the grasped surrounding state information to the driving state determining section 120. Note that instead of the recognition results acquired from the automated driving ECUs 60 and 70, the surrounding state grasping section 110 may grasp the surrounding state on the basis of information directly acquired from the locator ECU 34, the surrounding environment monitoring sensor 40 or the like.

The driver state estimating section 130 estimates the driver state on the basis of the information from the DSM 27, the vehicle control ECU 80 or the like. For example, the driver state estimating section 130 estimates, as the driver state, whether or not each body part of the driver is involved in driving operation. Specifically, on the basis of the state information or the like related to the line-of-sight direction of the driver acquired from the DSM 27, the driver state estimating section 130 assesses whether or not the eyes of the driver are performing surrounding environment monitoring. In addition, on the basis of the steering amount acquired from the vehicle control ECU 80, the driver state estimating section 130 assesses whether or not the driver is gripping the steering wheel with her/his hands. Additionally, on the basis of the step-on amount of the accelerator pedal acquired from the vehicle control ECU 80, the driver state estimating section 130 assesses whether or not the driver is placing her/his foot on the accelerator pedal.

Note that hereinbelow a state where the eyes are performing surrounding environment monitoring is written as eyes-on, and a state where the eyes are not performing surrounding environment monitoring is written as eyes-off, in some cases. In addition, a state where the driver is gripping the steering wheel with her/his hands is written as hands-on, and a state where the driver is not gripping the steering wheel with her/his hands is written as hands-off, in some cases. Additionally, a state where the driver is placing her/his foot on the accelerator pedal is written as leg-on, and a state where the driver is not placing her/his foot on the accelerator pedal is written as leg-off, in some cases. The driver state estimating section 130 serially provides the estimate state of each body part to the driving state determining section 120. Note that the driver state estimating section 130 may assess whether or not a driver condition mentioned later is satisfied.

The driving state determining section 120 determines a driving state related to automated driving by coordinated operation with the second automated driving ECU 70 and the first automated driving ECU 60. Specifically, the driving state determining section 120 determines, as the driving state, an automated driving level permitted for the driver, and an automated driving level to be executed actually.

On the basis of information from the surrounding state grasping section 110, the driving state determining section 120 determines that automated driving cannot be permitted in a case that the vehicle A is travelling in an MD area. On the other hand, the driving state determining section 120 determines that automated driving of Level 2 or higher can be permitted in a case that the vehicle A is travelling in an AD area. Furthermore, the driving state determining section 120 assesses that Level 2 automated driving can be permitted in a case that the vehicle A is travelling in a non-ST segment in an AD area, and assesses that Level 3 automated driving can be permitted in a case that the vehicle A is travelling in an ST segment.

Hereinbelow, a state where Level 2 automated driving is permitted is written as a “Level 2 permitted state,” and a state where Level 3 automated driving is permitted is written as a “Level 3 permitted state,” in some cases. In addition, a state where automated driving of Level 1 or higher is entirely prohibited is written as an “automated driving prohibited state” in some cases. The Level 2 permitted state is an example of a “particular action prohibited state,” and the Level 3 permitted state is an example of a “particular action permitted state.”

Additionally, in a case that it is determined that Level 2 automated driving is permitted, the driving state determining section 120 determines whether to or not to permit hands-off in Level 2. Specifically, on the basis of the execution state of LTA, the presence or absence of high-precision map data about a region around the vehicle A, the lane state, the surrounding environment monitoring state of the driver, geometries of roads around the vehicle A and the like, the driving state determining section 120 determines to permit hands-off in a case that a particular condition is satisfied.

For example, the particular condition includes at least one of that LTA control is being executed, that there is high-precision map data about a region around the vehicle A, that at least one of left and right markings of the current lane can be sensed, that it can be determined that the driver is performing surrounding environment monitoring, and that the travelling segment is not a segment with a complicated road structure. For example, a segment with a complicated road structure include a merging segment, a branching segment or the like. Hereinbelow, a state where hands-off is permitted is written as a “hands-off permitted state,” and a state where hands-off is prohibited is written as a “hands-off prohibited state,” in some cases. The hands-off permitted state is an example of a “state where hands are permitted to be off,” and the hands-off prohibited state is an example of a “state where hands are prohibited from being off.”

In addition, in a case that at least ACC is being executed in automated driving of Level 2 or lower, the driving state determining section 120 permits leg-off. Hereinbelow, a state where leg-off is permit is written as a “leg-off permitted state,” and a state where leg-off is prohibited is written as a “leg-off prohibited state,” in some cases. Additionally, in a case that Level 3 automated driving is permitted, the driving state determining section 120 permits eyes-off. That is, the Level 3 permitted state can be said to be an eyes-off permitted state.

On the basis of the currently permitted automated driving level, the driver state information, information input to the operation device 26 and the like, the driving state determining section 120 determines an automated driving level to be executed actually. That is, in a case that an instruction for starting the currently permitted automated driving level is acquired as input information, the driving state determining section 120 decides execution of the automated driving level. It should be noted that in a case that Level 3 automated driving is permitted during execution of Level 2 automated driving and additionally in a hands-on state, the driving state determining section 120 determines execution of Level 3 without acquiring input information. The driving state determining section 120 mentioned above is an example of a “judging section.”

As sub-functional sections, the presentation information adjusting section 140 has a presentation information choosing section 141, a content coordinating section 142 and a presentation information generating section 143. The presentation information adjusting section 140 is an example of “presentation control section.”

On the basis of information acquired from the surrounding state grasping section 110, the driving state determining section 120 and the driver state estimating section 130, the presentation information choosing section 141 controls presentation of contents related to automated driving in cooperation with the content coordinating section 142. Specifically, the presentation information choosing section 141 chooses contents to be presented on presentation devices on the basis of various types of information.

The content coordinating section 142 coordinates contents to be displayed on display devices. On the basis of various types of information from the presentation information choosing section 141, the content coordinating section 142 comprehensively determines priorities of the contents. The content coordinating section 142 chooses, as presentation-subject contents, contents that are determined to have high priorities. Additionally, in accordance with priorities, the content coordinating section 142 can serially change the display sizes and display layouts of contents to be displayed on display devices. As an example, the content coordinating section 142 increases display sizes as the priorities of contents increase. As another example, the content coordinating section 142 sets the position of a content in each display area in front of other contents as the priority of the content increases.

On the basis of results of the choice by the presentation information choosing section 141 and results of the coordination by the content coordinating section 142, the presentation information generating section 143 generates control signals and video data to be provided to each display device, and control signals and sound/voice data to be provided to the audio apparatus 24. By outputting the generated control signals and pieces of data to each presentation device, the presentation information generating section 143 implements information presentation on each presentation device.

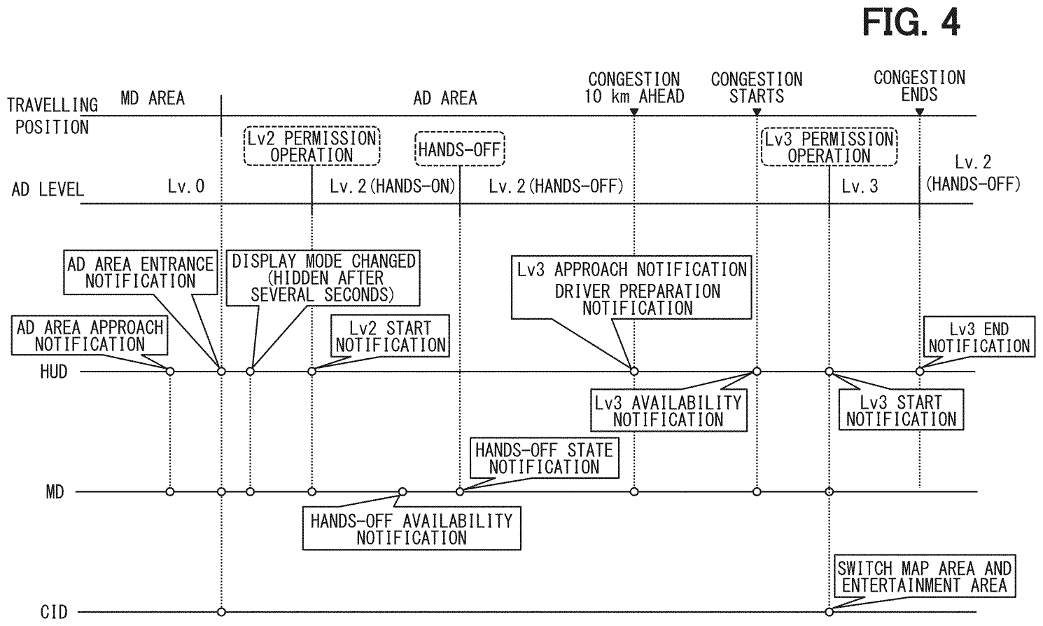

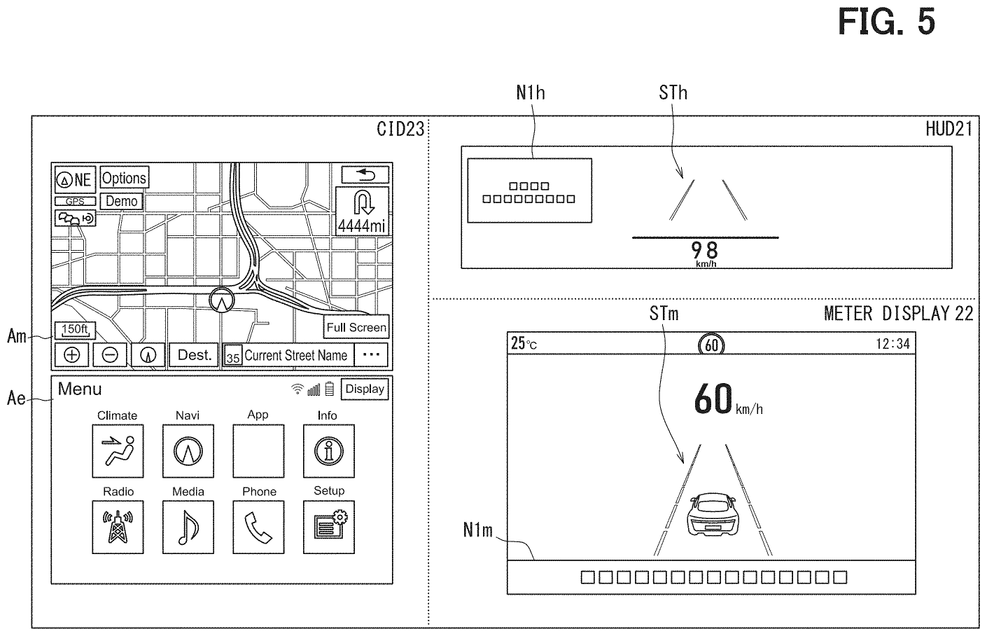

Next, contents that the HCU 100 causes to be presented are explained below by using FIG. 5 to FIG. 18 with reference to a time chart in FIG. 4. Regarding automated driving, the HCU 100 implements AD area approach notification, AD area entrance notification, Level 2 start notification, Level 3 approach notification, driver preparation notification, Level 3 availability notification, Level 3 start notification, Level 3 end notification and the like.

The AD area approach notification is implemented in a case that an AD area is approaching during travelling in an MD area. Specifically, the AD area approach notification is implemented in a case that the surrounding state grasping section 110 determines the distance from the vehicle A to an AD area has fallen below a threshold distance. As depicted in FIG. 5, in the AD area approach notification, the presentation information adjusting section 140 causes AD area approach messages N1h and N1m to be displayed on the HUD 21 and the meter display 22.

The AD area approach messages N1h and N1m are image contents representing, as visual information, that an AD area is approaching. The AD area approach message N1h displayed on the HUD 21 is displayed in the angle of view VA along with a digital speed meter, a driving status STh and the like. The AD area approach message N1h is arranged on the left or right side of the driving status STh arranged in a middle area in the angle of view VA. The AD area approach message N1h includes a message image, and a frame-shaped window image surrounding the message image. For example, the message image is text information with a text representing that an AD area is approaching such as “soon entering automated driving available area.”

The AD area approach message N1m displayed on the meter display 22 is displayed in a display screen along with a driving status STm and the like. For example, the AD area approach message N1m is arranged along the lower edge in the display screen. The AD area approach message N1m is displayed in front of the driving status STm. The AD area approach message N1m includes a message image, and a strip-like window image in front of which the message image is arranged. Similarly to the HUD 21, the message image is text information representing that an AD area is approaching. The window image is displayed in a color (e.g. blue) which is different from the background of the driving status STm.

Note that the AD area approach notification mentioned above is implemented irrespective of the level of automated driving that is available after entering the AD area. That is, as depicted in FIG. 4, not only in a case that an AD area where Level 2 is available is approaching in an MD area, but also in a case that an AD area where automated driving of Level 3 or higher is available is approaching in an MD area, the AD area approach notification is implemented.

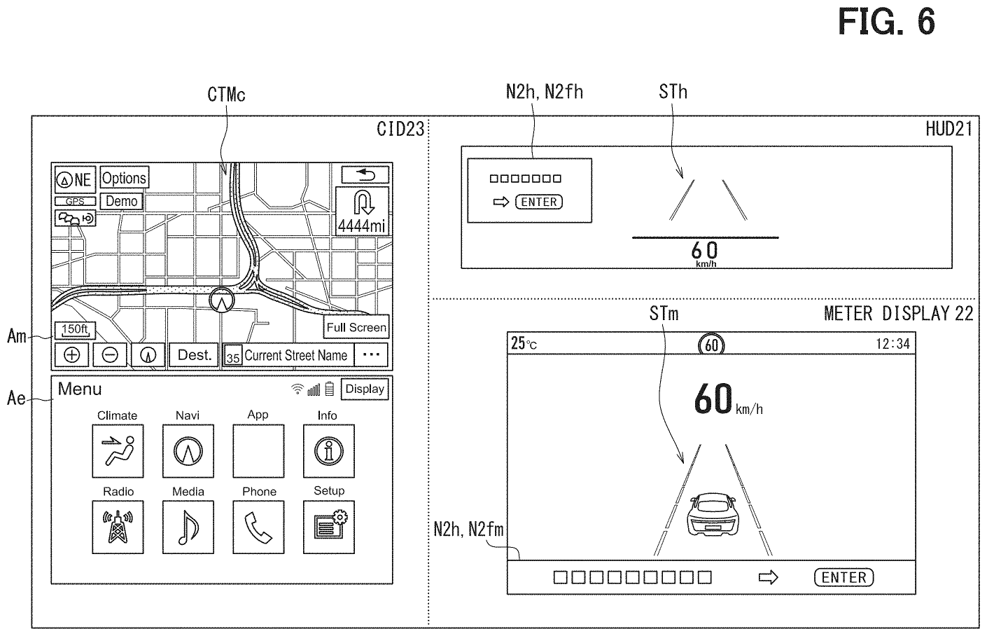

The AD area entrance notification is implemented in a case that the surrounding state grasping section 110 has determined that the vehicle A has entered the AD area after the AD area approach notification. As depicted in FIGS. 6, 7 and 8, in the AD area entrance notification, the presentation information adjusting section 140 causes AD area entrance messages N2h and N2m to be displayed on the HUD 21 and the meter display 22, and causes an AD area notification content CTMc to be displayed on the CID 23.

The AD area entrance messages N2h, N2m and N2c are image contents representing, as visual information, that the vehicle A has entered the AD area. The display modes of the AD area entrance messages N2h and N2m displayed on the HUD 21 and the meter display 22 change along with the elapse of predetermined change time since the start of the display. Hereinbelow, AD area entrance messages before the change are called first AD area entrance messages N2fh and N2fm, and AD area entrance messages after the change are called second AD area entrance messages N2sh and N2sm.

For example, the first AD area entrance message N2fh displayed on the HUD 21 is arranged at substantially the same position as the AD area approach message N1h, and, similarly to the AD area approach message N1h, includes a message image and a frame-shaped window image. The message image is text information related to entrance to the AD area, and, for example, the message is a text representing a method for starting automated driving. Specifically, the message image includes a text “AUTOMATED DRIVING MODE,” a text “ENTER” representing input to the operation device 26 and an arrow pointing “ENTER.” Thereby, a first AD area approach message N1fh notifies that automated driving mode can be started if there is input to the operation device 26, and this presents, to the driver, a message that the vehicle A has entered an AD area where automated driving is available.

For example, the first AD area entrance message N2fm displayed on the meter display 22 is arranged at substantially the same position as the AD area approach message N1m. Similarly to the AD area approach message N1m, the first AD area entrance message N2fm includes a message image and a strip-like window image in front of which the message image is arranged. Similarly to the first AD area entrance message N2fh, the message image is text information related to entrance into the AD area. Specifically, the message image includes a text “USE AUTOMATED DRIVING MODE,” a text “ENTER” representing input to the operation device 26 and an arrow pointing “ENTER.”

The first AD area entrance messages N2fh and N2fm mentioned above are changed to the second AD area entrance messages N2sh and N2sm after the elapse of predetermined change time (e.g. several seconds). The second AD area entrance messages N2sh and N2sm are displayed in modes with lower visibility than that of the first AD area entrance messages N2fh and N2fm. Specifically, by applying at least one of reduction of display sizes, changes of display colors, changes of display positions, reduction of display luminance, hiding parts of them and the like, the second AD area entrance messages N2sh and N2sm are displayed in modes with low visibility. For example, the second AD area entrance message N2sh displayed on the HUD 21 is has a hidden window image, is displayed at a lower position in the angle of view VA, and furthermore has a smaller display size. In addition, the second AD area entrance message N2sm displayed on the meter display 22 has a message image which is partly hidden and a window image which is hidden, and has a smaller display size.

The AD area notification content CTMc displayed on the CID 23 is a map image displayed in a map display area Am in a display mode which is different from that before the AD area notification. For example, the AD area notification content CTMc is a map image of a region around the vehicle A and displays the AD area while making a distinction between the AD area and the MD area. Specifically, the areas are displayed in different display colors in the area image. The AD area notification image N2c starts being displayed substantially simultaneously with the first AD area entrance messages N2fh and N2fm in a case that it is determined that the vehicle A has entered the AD area. The display mode of the AD area notification content CTMa is not changed even after the elapse of predetermined change time.

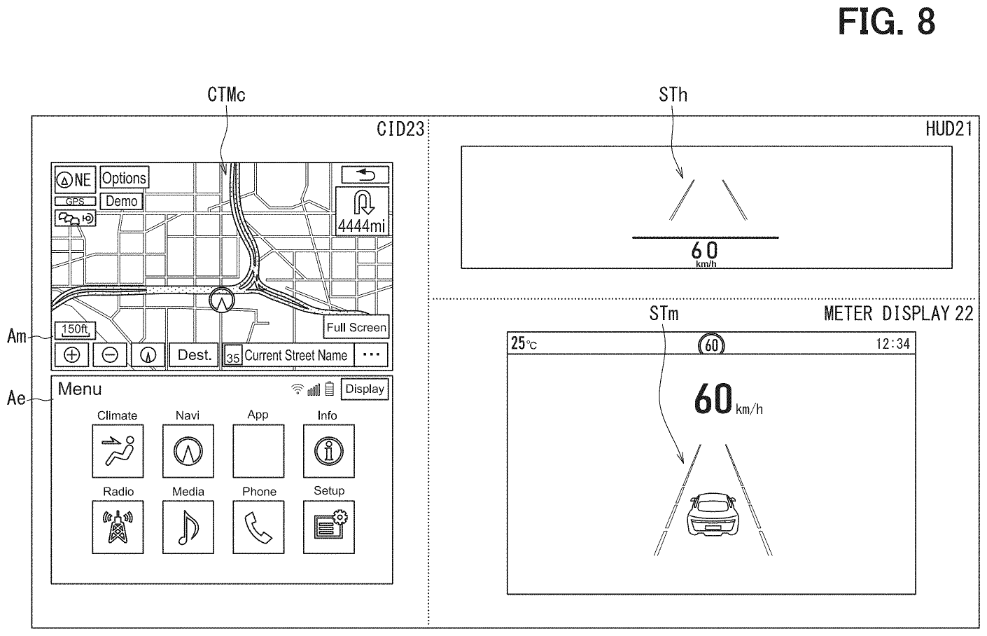

The AD area entrance messages N2h and N2m displayed on the HUD 21 and the meter display 22 in the AD area entrance messages N2h, N2m and CTMc mentioned above are displayed for display tolerated time (e.g. approximately five to ten seconds). In a case that input information for starting automated driving is not acquired from the operation device 26 during the display tolerated time, the AD area entrance messages N2h and N2m are hidden after the elapse of the tolerated time. On the other hand, the AD area notification content CTMc keeps being displayed even after the elapse of the display tolerated time (see FIG. 8). That is, after the elapse of the display tolerated time, the entrance notification is continued on a smaller number of display devices. For example, the AD area notification content CTMc keeps being displayed until input information for starting automated driving is acquired.

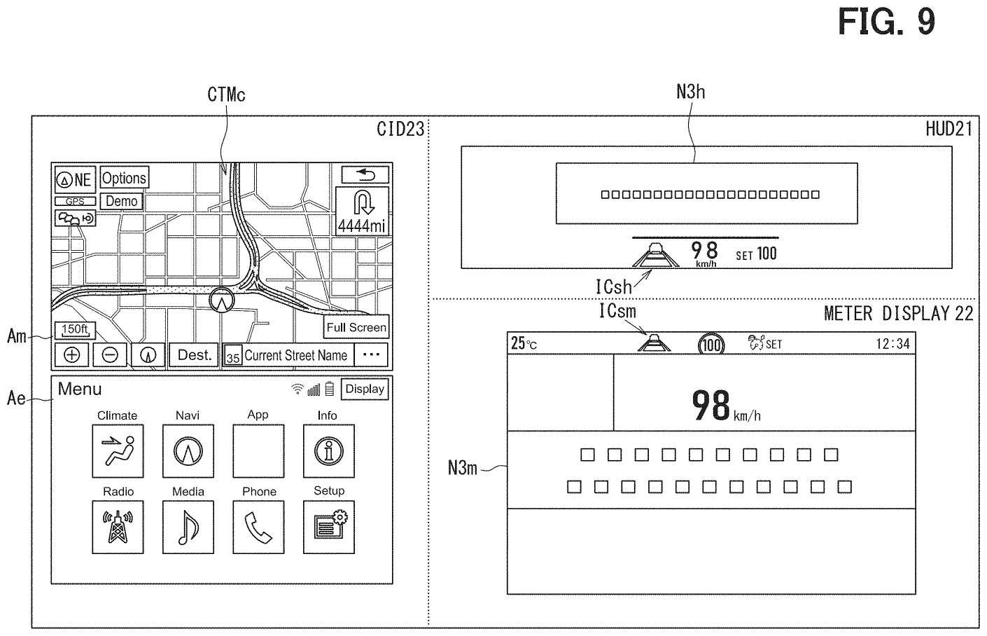

The Level 2 start notification is implemented in a case that the driving state determining section 120 determines that Level 2 automated driving is started. As depicted in FIG. 9, in the Level 2 start notification, the presentation information adjusting section 140 causes Level 2 start messages N3h and N3m to be displayed on the HUD 21 and the meter display 22.

The Level 2 start messages N3h and N3m are image contents representing, as visual information, that Level 2 automated driving is started. For example, the Level 2 start messages N3h and N3m include message images with text information which is a text related to the start of automated driving, and window images that define the boundaries of the message images in display areas. For example, the message images are texts stating that there is a possibility that automated driving having been started is cancelled such as “Automated driving is cancelled depending on surrounding road situation.” The Level 2 start messages N3h and N3m are arranged in middle portions of the display areas. The Level 2 start messages N3h and N3m are displayed in front of the driving statuses STh and STm.

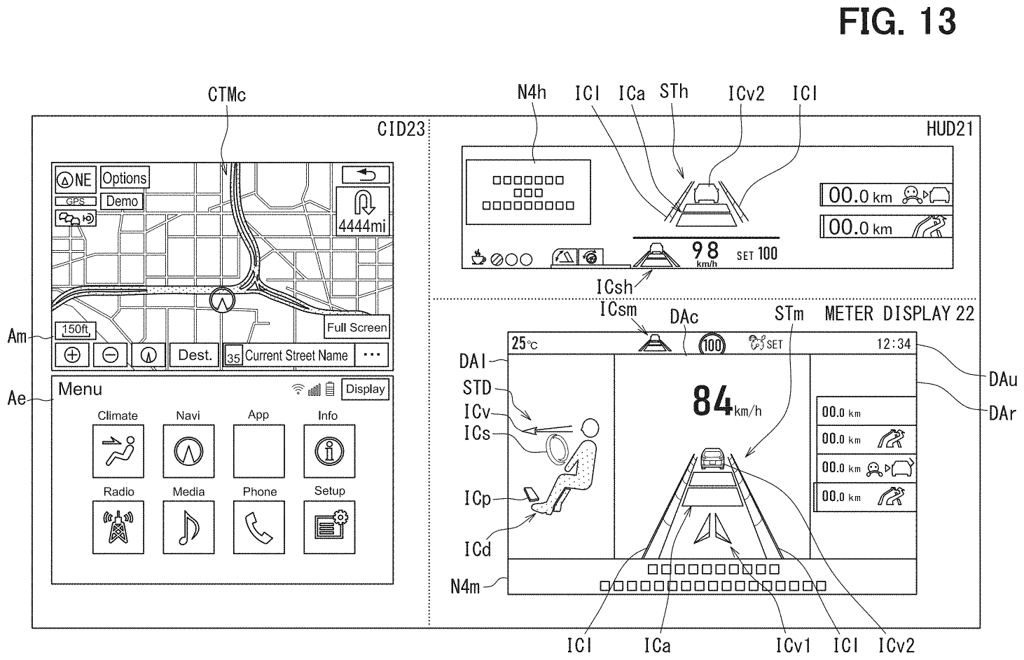

The Level 3 approach notification notifies that an ST segment where Level 3 automated driving is available is approaching. The Level 3 approach notification is executed in a case that, during travelling in an MD area or a non-ST segment in an AD area, the remaining distance from the vehicle A to an ST segment has fallen below a threshold (e.g. approximately 10 km). As depicted in FIG. 13, in the Level 3 approach notification, the presentation information adjusting section 140 causes Level 3 approach messages N4h and N4m to be displayed on the HUD 21 and the meter display 22.

The Level 3 approach messages N4h and N4m are image contents representing, as visual information, that an ST segment is approaching. For example, the Level 3 approach message N4h displayed on the HUD 21 is arranged at substantially the same position as the AD area approach message N1h, and, similarly to the AD area approach message N1h, includes a message image and a frame-shaped window image. For example, the message image is text information with a text representing that an ST segment is approaching such as “congestion approximately 10 km ahead; 2nd task allowed.”

For example, the Level 3 approach message N4m displayed on the meter display 22 is arranged at substantially the same position as the AD area approach message N1m. Similarly to the AD area approach message N1m, the Level 3 approach message N4m includes a message image and a strip-like window image in front of which the message image is arranged. For example, similarly to the display of the HUD 21, the message image is text information with a text representing that an ST segment is approaching such as “congestion approximately 10 km ahead; 2nd task allowed during congestion.”

Note that in a case that there is a transition (first transition) from an automated driving prohibited state to a Level 3 available state, the Level 3 approach notification and the AD area approach notification are implemented simultaneously. At this time, the Level 3 approach notification and the AD area approach notification may be given in one notification.

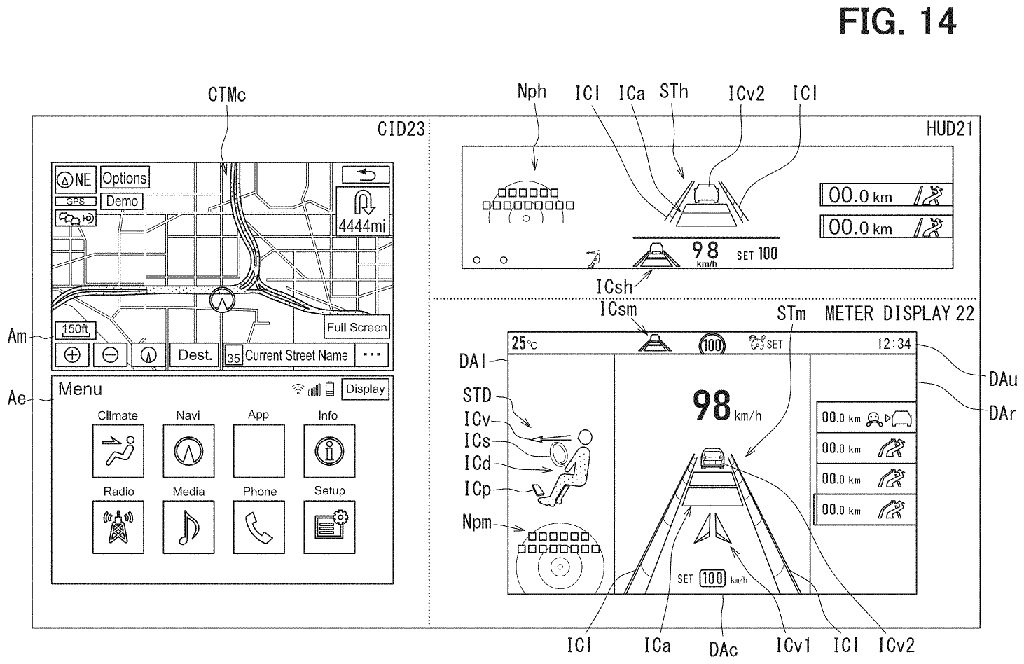

The driver preparation notification is a notification prompting the driver to satisfy a condition (driver condition) for implementing Level 3. The driver preparation notification is executed in a case that the driver condition is not satisfied at the start of the Level 3 approach notification. For example, the driver condition is that the arousal of the driver is higher than a threshold level, that the posture type of the driver is a predefined posture type, or the like. Furthermore, the driver condition may be that the stress level is lower than a threshold level, the elapsed time since the start of travelling is longer than predetermined time, or the like. The driver preparation notification may be executed simultaneously with the Level 3 approach notification. For example, it is started after execution of the Level 3 approach notification. As depicted in FIG. 14, in the driver preparation notification, the presentation information adjusting section 140 causes driver preparation messages Nph and Npm to be displayed on the HUD 21 and the meter display 22.

For example, each of the driver preparation messages Nph and Npm include a window image and a message image. The message image is a text prompting the driver to exhibit predetermined behavior such that the driver condition which is not satisfied is satisfied. For example, the driver preparation message Nph displayed on the HUD 21 is displayed at a position similar to the position of the Level 3 approach message N4h. For example, the driver preparation message Npm displayed on the meter display 22 is displayed below a driver status STD in the same display area as the driver status STD.

The Level 3 availability notification notifies that a Level 3 available state has started due to entrance into an ST segment. The Level 3 availability notification is executed in a case that the vehicle A has entered an ST segment of an AD area from a non-ST segment, that is, in a case that there is a transition (second transition) from a Level 2 available state to a Level 3 available state. Additionally, the Level 3 availability notification is executed in a case that the vehicle A has entered an ST segment from an MD area, that is, in a case that there is a transition (first transition) from an automated driving prohibited state to a Level 3 available state. That is, the Level 3 availability notification is executed simultaneously with the AD area entrance notification in some cases. In addition, the Level 3 availability notification and the AD area entrance notification may be given in one notification.

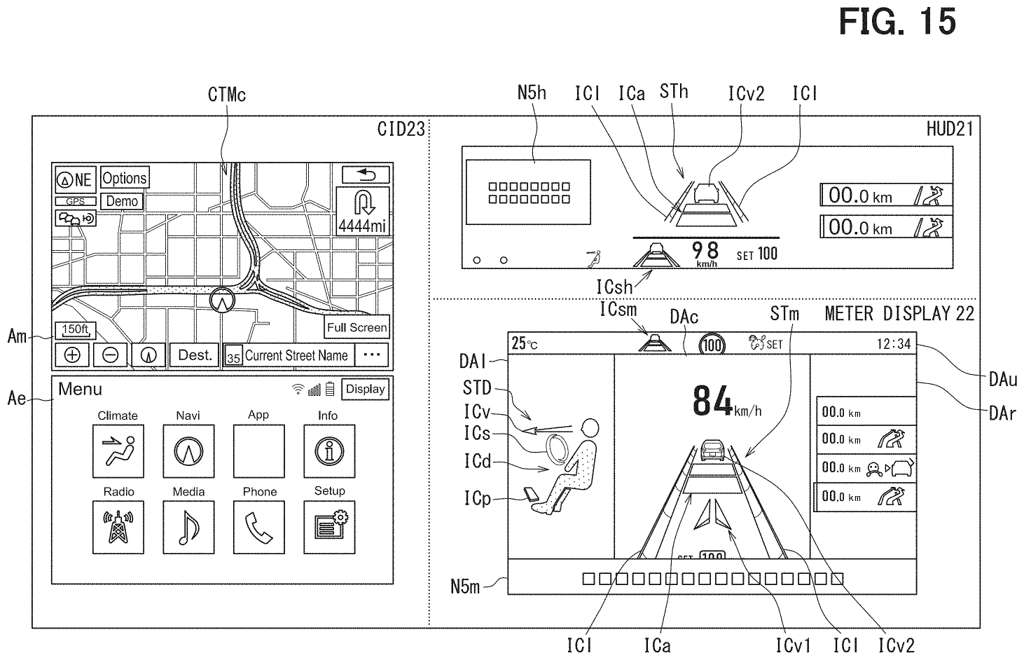

As depicted in FIG. 15, in the Level 3 availability notification, the presentation information adjusting section 140 causes Level 3 availability messages N5h and N5m to be displayed on the HUD 21 and the meter display 22. Additionally, the presentation information adjusting section 140 causes a Level 3 availability notification sound to be presented by the audio apparatus 24 in a case that there is the first transition. Thereby, the presentation information adjusting section 140 presents, to the driver, information related to the first transition (first transition information) in a more emphasized manner than it does for information related to the second transition (second transition information).

The Level 3 availability messages N5h and N5m are image contents representing entrance into an ST segment as visual information. For example, the Level 3 availability message N5h displayed on the HUD 21 is arranged at substantially the same position as the AD area approach message N1h, and, similarly to the AD area approach message N1h, includes a message image and a frame-shaped window image. For example, the message image is text information with a text representing entrance into an ST segment such as “2nd task is allowed.”

For example, the Level 3 availability message N5m displayed on the meter display 22 is arranged at substantially the same position as the AD area approach message N1m. Similarly to the AD area approach message N1m, the Level 3 approach message N4m includes a message image and a strip-like window image in front of which the message image is arranged. For example, the message image is substantially the same as the one displayed on the HUD 21.

The Level 3 availability notification sound is a sound content representing, as auditory information, that the Level 3 automated driving is available. The Level 3 availability notification sound may be a sound effect or may be a sound/voice message.

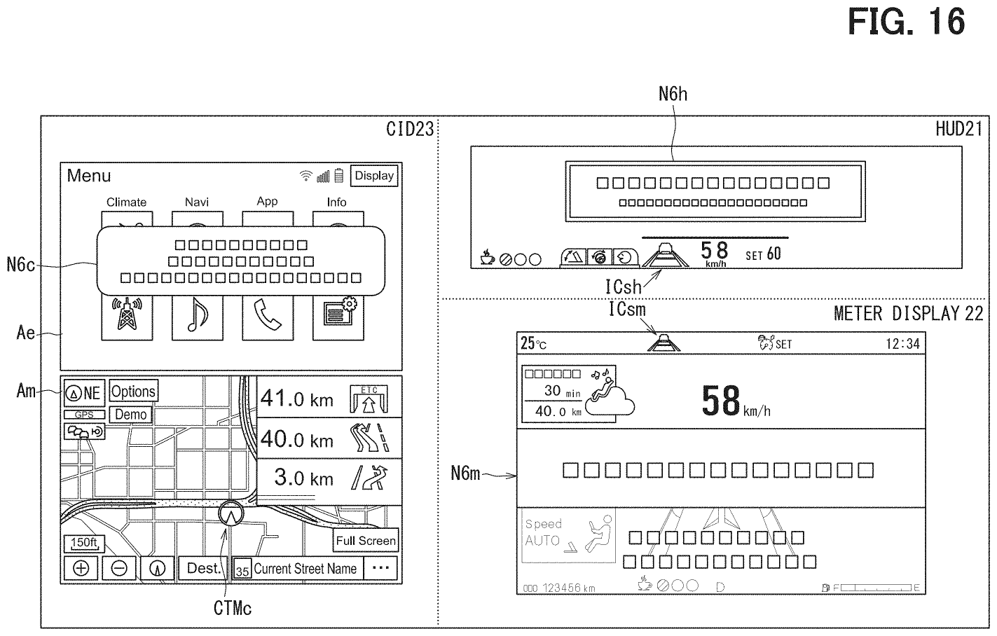

The Level 3 start notification notifies that the Level 3 automated driving is started. In the first embodiment, the Level 3 start notification is executed after receiving a Level 3 start instruction from the driver in a case that there is a transition from manual driving, Level 1 or hands-on in Level 2 to Level 3. On the other hand, the Level 3 start notification is executed after entering an ST segment in a case that there is a transition from hands-off in Level 2 to Level 3. In this case, the Level 3 start notification is executed simultaneously with the Level 3 availability notification. As depicted in FIG. 16, in the Level 3 start notification, the presentation information adjusting section 140 causes Level 3 start messages N6h, N6m and N6c to be displayed on the HUD 21, the meter display 22 and the CID 23.

The Level 3 start messages N6h, N6m and N6c are image contents representing, as visual information, that the Level 3 automated driving is started.

For example, the Level 3 start message N6h displayed on the HUD 21 is arranged at substantially the same position as the Level 2 start message N3h, and includes a message image and a frame-shaped window image. For example, the message image is text information with a text related to the start of the Level 3 automated driving such as “Be careful of information from vehicle; automated driving is cancelled depending on surrounding road situation.”

For example, the Level 3 start message N6m displayed on the meter display 22 is arranged at substantially the same position as the Level 2 start message N3h, and includes a message image and a frame-shaped window image. For example, the message image is substantially the same as the one displayed on the HUD 21.

For example, the Level 3 start message N6c displayed on the CID 23 is displayed near a middle area in an entertainment display area Ae. The Level 3 start message N6c is displayed in front of other display contents in the entertainment display area Ae. The Level 3 start message N6c includes a message image and a window image arranged behind the message image. For example, the message image is a text related to the start of the Level 3 automated driving similar to the message images on the HUD 21 and the meter display 22 such as “Automated driving is cancelled depending on surrounding road environment; be careful of information given from vehicle.”

Additionally, in the Level 3 start notification, the presentation information adjusting section 140 switches the map display area Am and the entertainment display area Ae on the CID 23. Specifically, the presentation information adjusting section 140 causes the entertainment display area Ae to be displayed above the map display area Am.

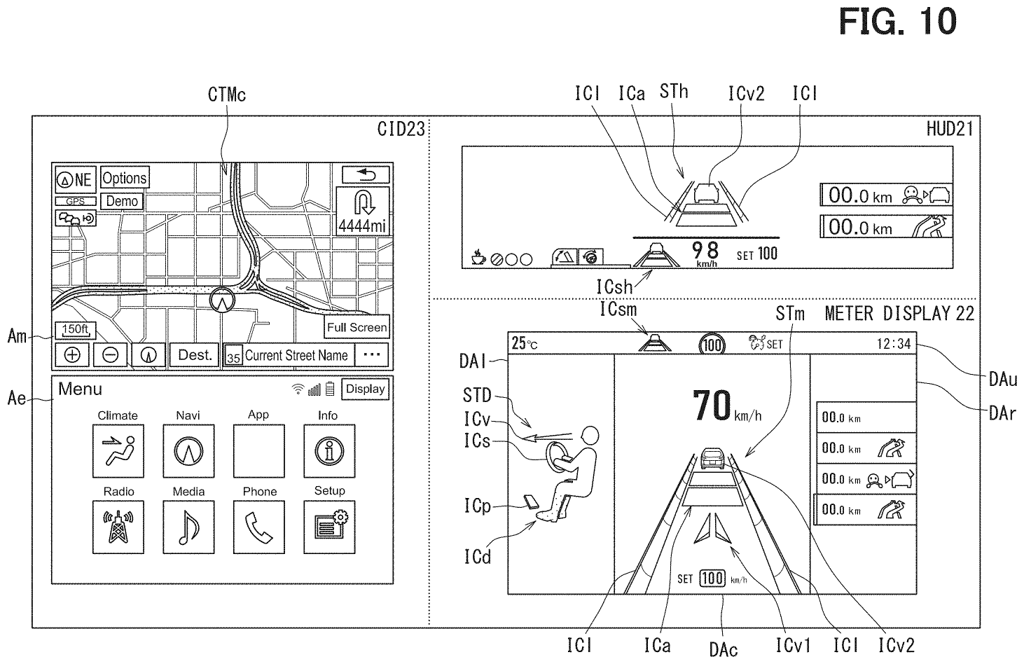

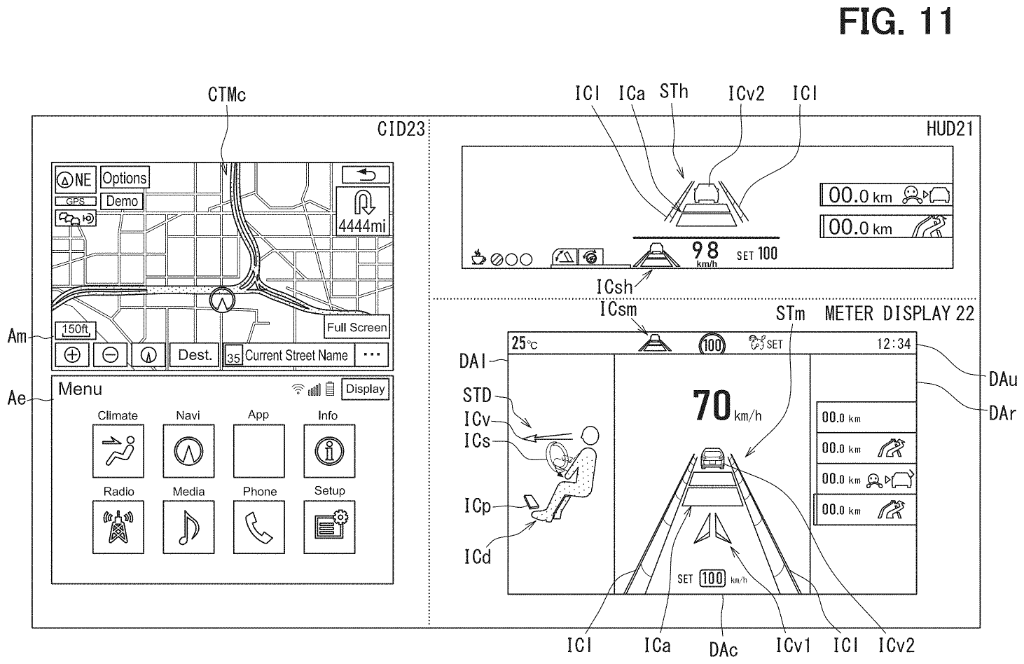

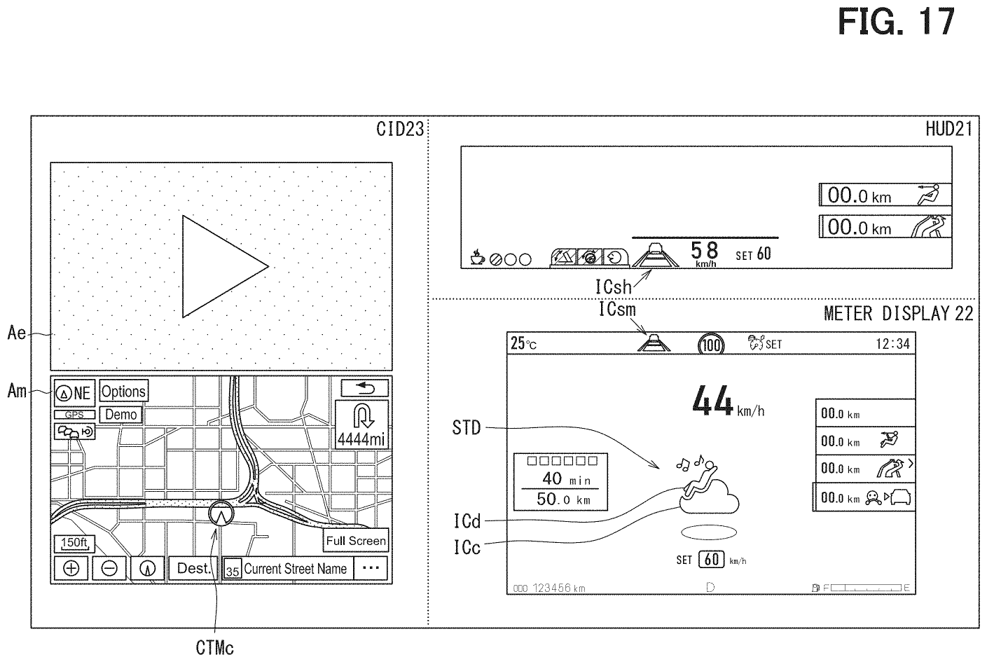

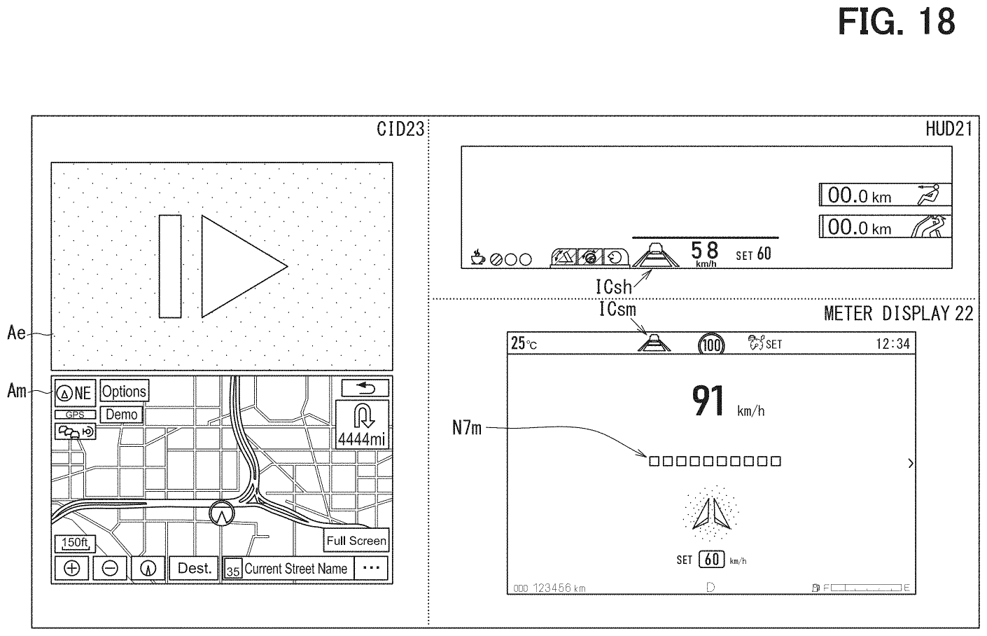

The Level 3 end notification is executed in a case that there is a transition from Level 3 automated driving to automated driving of Level 2 or lower or manual driving. The presentation information adjusting section 140 makes a transition from the information presentation in FIG. 17 to the information presentation in FIG. 10 or FIG. 11 as the Level 3 end notification in a case that there is a transition from Level 3 automated driving to Level 2 permitted state. In addition, the presentation information adjusting section 140 makes a transition from the information presentation in FIG. 17 to the information presentation in FIG. 8 as the Level 3 end notification in a case that there is a transition from Level 3 automated driving to a manual driving state. Other than these, as depicted in FIG. 18, the presentation information adjusting section 140 causes a Level 3 end message N7m to be displayed on the meter display 22 as the Level 3 end notification. Additionally, the presentation information adjusting section 140 causes a Level 3 end notification sound to be output by the audio apparatus 24.

The Level 3 end message N7m is an image content representing, as visual information, that the Level 3 automated driving is ended. For example, in a case that there is a transition to manual driving, the Level 3 end message N7m is a message image including text information with a text related to the end of automated driving such as “Automated driving mode being cancelled” (see FIG. 18). In addition, in a case that there is a transition to automated driving of Level 2 or lower, the message image may be one including text information with a text prompting to end second tasks, start necessary driving operation and so on.

Note that in a case that an override of performing steering operation is executed by the driver during automated driving of Level 2 or higher, as depicted in FIG. 18, the presentation information adjusting section 140 gives a notification representing that the automated driving mode is cancelled temporarily. Then, the presentation information adjusting section 140 stops or hide the display content in the entertainment display area Ae during the override.

The Level 3 end notification sound is a sound content representing, as auditory information, that the Level 3 automated driving is ended. The Level 3 end notification sound may be a sound effect or may be a sound/voice message.

It should be noted that, in a case that there is a transition to a hands-off permitted state (fourth transition), the presentation information adjusting section 140 suspends presentation of the Level 3 end notification sound. That is, the presentation information adjusting section 140 presents the Level 3 end notification sound in a case that there is a transition to a hands-off prohibited state (third transition) after the transition, and does not present the Level 3 end notification sound in a case that hands-on is not necessary after the transition. Thereby, the presentation information adjusting section 140 presents, to the driver, information related to the third transition (third transition information) in a more emphasized manner than it does for information related to the fourth transition (fourth transition information).

Here, contents that the presentation information adjusting section 140 displays continuously during implementation of automated driving are explained with reference to FIGS. 10 to 12 and the like. The presentation information adjusting section 140 displays the driving statuses STh and STm, status icons ICsh and ICsm, the driver status STD and the like during implementation of automated driving of Level 2 or lower.

The driving statuses STh and STm are contents to be displayed on the HUD 21 and the meter display 22. The driving statuses STh and STm present the operating states of control in the longitudinal direction and control in the lateral direction, that is, an ACC functionality and an LTA functionality, in automated driving of Level 2 or lower. The driving statuses STh and STm include a non-user's car icon ICv2, ACC icons ICa and LTA icons ICI. Note that the driving status STm displayed on the meter display 22 also displays a user's vehicle icon ICv1 in addition to the contents mentioned above.

The non-user's car icon ICv2 is an icon imitating a non-user's vehicle, and is displayed at least while the ACC functionality is being executed or a preceding vehicle is being sensed. ACC icons ICah and ICam are icons that represent execution of ACC control, are displayed while the ACC control is being executed, and, when the ACC control is stopped, are hidden or displayed in modes that are different from those during execution. The ACC icons ICa are illustrations arranged next to each other below the non-user's car icon ICv2, and are visually recognized as being next to each other following the preceding vehicle represented by the non-user's car icon ICv2 due to the law of perspective. LTA icons IClh and IClm are icons that representing execution of LTA control, are displayed while the LTA control is being executed, and, when the LTA control is stopped, are hidden or displayed in modes that are different from those during execution. The LTA icons ICI are arranged on both left and right sides of the non-user's car icon ICv2 and the ACC icons ICa, and have shapes that are visually recognized as a pair of lines extending from the nearer side to the farther side.

The driving status STm on the meter display 22 is displayed collectively in one of a plurality of display areas formed by dividing the display screen of the meter display 22. For example, the display area of the meter display 22 is divided into four, an upper area DAu, a lower left area DAI, a lower central area DAc and a lower right area DAr. Note that the display areas are ones that are formed by visually dividing the display area of the meter display 22 by differences among background colors of the display areas, display of frame images or the like by the presentation information adjusting section 140. The driving status STm is displayed in the lower central area DAc.

Similarly to the driving statuses STh and STm, the status icons ICsh and ICsm are icons representing the execution states of control in the longitudinal direction and control in the lateral direction. The status icon ICsm is displayed in the upper area DAu. For example, the status icons ICsh and ICsm are an icon imitating the non-user's vehicle, an icon representing execution of the ACC control and an icon representing execution of the LTA control, and are more simplified than corresponding ones in the driving statuses STh and STm. Note that the status icons ICsh and ICsm may be displayed continuously also in automated driving of Level 3 or higher.

A future behavior content is a content notifying planned future behavior of the vehicle A, and is displayed in the lower right area DAr. For example, the future behavior content includes an icon representing the future behavior, and a numerical value image representing the distance to a geographical point where the future behavior is implemented. The future behavior includes a lane change, making a right or left turn, merging or the like. Additionally, the future behavior may include take-over of the control by the driver, a change of the automated driving level or the like.

The driver status STD is a content representing the state of the driver related to driving operation. The driver status STD is displayed in the lower left area DAI of the meter display 22. Regarding each of multiple types of body part of the driver, the driver status STD presents an applicable state of a suspension permitted state where suspension of driving operation is permitted and a suspension prohibited state where suspension of driving operation is prohibited. For example, the driver status STD represents the suspension permitted state or the suspension prohibited state about driving operation like surrounding environment monitoring by the eyes, gripping of the steering wheel by the hands or placing a foot on a pedal. The driver status STD displays the state of each body part in the same display area.

Specifically, the driver status STD includes a driver icon ICd, a steering wheel icon ICs, a pedal icon ICp and a line-of-sight icon ICv. The driver icon ICd is a human-shaped icon. Specifically, the driver icon ICd has a shape imitating the body of one human including, as body parts, the arms, the feet and the head, which is a part including the eyes. That is, the driver icon ICd is a content displaying the body parts collectively. Thereby, the driver icon ICd represents the body parts proximately to each other in the lower left area DAI. The driver icon ICd may be one unified content or may be a content in which the body parts are spaced apart from each other.

The steering wheel icon ICs is an icon image imitating the steering wheel. In addition, the pedal icon ICp is an icon imitating an accelerator pedal. The line-of-sight icon ICv is an icon represent the line of sight of the driver. For example, the line-of-sight icon ICv is an arrow shape extending from near the head of the driver icon ICd in a direction that the head faces (the leftward direction in cases of FIGS. 10 to 12 and the like).

The driver status STD displays a state permitted for the driver regarding driving operation by coordinated display of the icons. For example, in a case of a hands-off prohibited state where hands-off is prohibited, the hands of the driver icon ICd and the steering wheel icon ICs are displayed such that they overlap. In a case of a hands-off permitted state where hands-off is permitted, the hands of the driver icon ICd and the steering wheel icon ICs are displayed such that they are apart from each other. Additionally, the visibility of the steering wheel icon ICs is lowered.

In addition, in a case of a leg-off prohibited state where leg-off is prohibited, the feet of the driver icon ICd and the pedal icon ICp are displayed such that they overlap. Additionally, the visibility of the pedal icon ICp is lowered. In a case of a leg-off permitted state where leg-off is permitted, the feet of the driver icon ICd and the pedal icon ICp are displayed such that they are apart from each other. Furthermore, in a case of an eyes-off prohibited state where eyes-off is prohibited, the line-of-sight icon ICv is displayed, and in a case of an eyes-off permitted state where eyes-off is permitted, the visibility of the line-of-sight icon ICv is lowered.

Regarding each body part, the presentation information adjusting section 140 notifies a state transition between the suspension prohibited state and the suspension permitted state by using the driver status STD mentioned above (transition notification). The suspension prohibited states include the hands-off prohibited state, the leg-off prohibited state and the eyes-off prohibited state. The suspension permitted states include the hands-off permitted state, the leg-off permitted state and the eyes-off permitted state. At this time, the presentation information adjusting section 140 changes the mode of the driver status STD by animation display. Specifically, the presentation information adjusting section 140 presents a state transition by animation display about a displayed part corresponding to a body part in the driver icon ICd whose state makes a transition.

The animation display is stopped when it is estimated that the corresponding body part of the driver has actually made a transition to the state corresponding to the state. In addition, the presentation information adjusting section 140 stops the animation also in a case that the corresponding body part of the driver has not made a transition to the suspended state (hands-off, leg-off, eyes-off) in a predetermined period. In this case, the presentation information adjusting section 140 may use, as the mode after the animation is stopped, a display mode of the suspension prohibited state, that is, a mode corresponding to the current state of the body part.

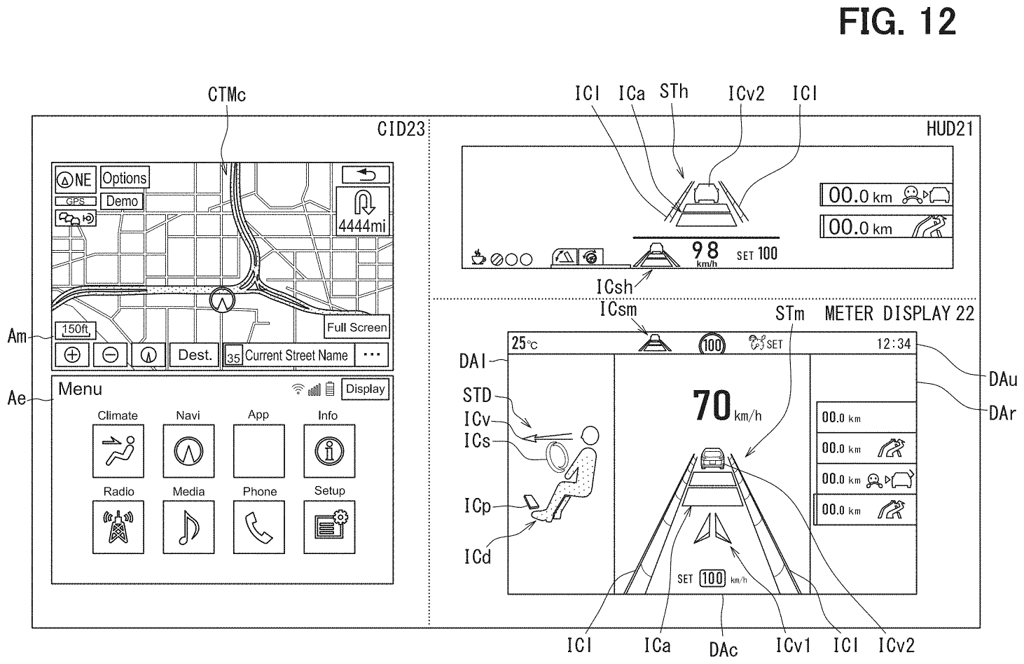

For example, in a case that there is a transition from the hands-off prohibited state to the hands-off permitted state, the presentation information adjusting section 140 displays an animation in which the hands of the driver icon ICd move from positions in the hands-off prohibited state to positions in the hands-off permitted state (see FIG. 11). The presentation information adjusting section 140 displays the animation mentioned above repeatedly. After the driver has actually made a transition to the hands-off state, the presentation information adjusting section 140 stops the animation, and switches to the display mode of the hands-off state (see FIG. 12).

Additionally, in a case that there is a transition from the hands-off prohibited state to the hands-off permitted state, the presentation information adjusting section 140 lowers the luminance, and so on to thereby lower the visibility of the steering wheel icon ICs. The presentation information adjusting section 140 may lower the visibility of the steering wheel icon ICs in synchronization with the animation display of the driver icon ICd repeatedly or after the animation of the driver icon ICd is stopped.

In addition, similarly, in a case that there is a transition from the leg-off prohibited state to the leg-off permitted state also, the presentation information adjusting section 140 displays an animation in which the feet of the driver icon ICd move from positions in the leg-off prohibited state to positions in the leg-off permitted state. Additionally, the presentation information adjusting section 140 lowers the visibility of the pedal icon ICp.

Note that similarly in a case that there is a transition from the suspension permitted state to the suspension prohibited state also, the presentation information adjusting section 140 presents a state transition by animation display. In this case, the presentation information adjusting section 140 may continue the animation display until a corresponding body part of the driver has actually made a transition to a driving-related state.

In addition, in the Level 3 execution state, the driver status STD is displayed in a mode different from that in a case of a state of Level 2 or lower. For example, the driver status STD in the Level 3 execution state is displayed in a display mode in which the driver icon ICd is seated on a seat icon ICc. At this time, the driver icon ICd is displayed as a human-shaped icon at a posture reclined backward than in a case of Level 2 or lower. The steering wheel icon ICs and the pedal icon ICp are hidden.

Note that the line-of-sight icon ICv, the steering wheel icon ICs and the pedal icon ICp may be hidden, instead of being displayed with lowered visibility. The line-of-sight icon ICv, the steering wheel icon ICs and the pedal icon ICp may be displayed in a case that there is a change of driving operation that makes it necessary to display them along with the driver icon ICd.

In addition, in a case that there is a transition from the Level 3 automated driving state to the hands-on Level 2 automated driving state, the line-of-sight icon ICv and the steering wheel icon ICs are changed from a hidden state to a displayed state or changed from a display state to a state where they are displayed in an emphasized manner in order to prompt the driver to make a transition to an eyes-on state and a hands-on state. At this time, the line-of-sight icon ICv and the steering wheel icon ICs may be displayed simultaneously or may be displayed sequentially.

By displaying the line-of-sight icon ICv and the steering wheel icon ICs simultaneously, a state that is permitted for the driver regarding driving operation can be informed quickly to the driver.

On the other hand, in a case that there is a transition from the Level 3 automated driving state to the hands-on Level 2 automated driving state, the driver is required to performed a lot of driving operation, so tasks that the driver should perform increase undesirably, and there is a possibility that this confuses the driver. In view of this, by displaying the line-of-sight icon ICv and the steering wheel icon ICs sequentially, the driver is allowed to perform tasks one at a time, and so can perform driving operation safely.

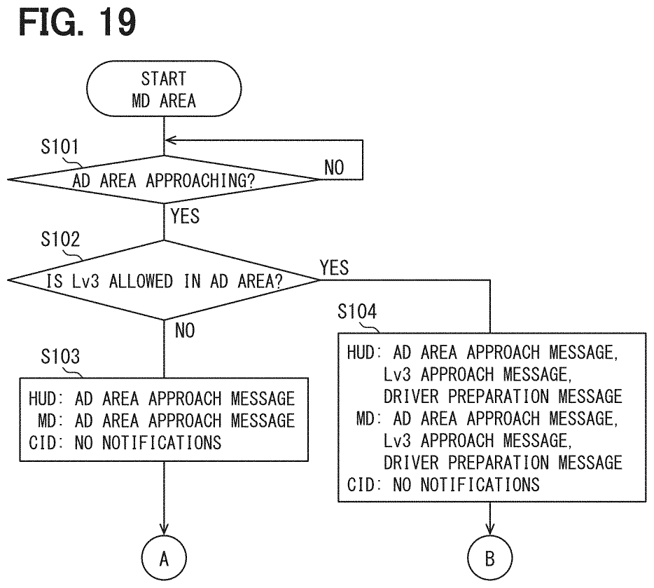

Next, a procedure of a presentation control method executed by the HCU 100 by coordinated operation of functional blocks is explained below according to FIGS. 19 to 24 with reference to FIGS. 2 to 18. In FIGS. 19 to 24, the meter display 22 is written as “MD.” Note that “S” in the procedure mentioned later means a plurality of steps in the procedure executed by a plurality of commands included in the presentation control program.

First, a procedure in a scene where the vehicle A enters an AD area from an MD area is explained (see FIGS. 19 to 21). At S101 in FIG. 19, the surrounding state grasping section 110 assesses whether or not an AD area is approaching. In a case that it is assessed that an AD area is not approaching, the procedure waits until an AD area approaches. If it is assessed that an AD area is approaching, at S102, the surrounding state grasping section 110 assesses whether or not Level 3 automated driving is available after entering the AD area. In a case that it is assessed that Level 3 automated driving is not available, that is, only automated driving of Level 2 or lower is available, the procedure proceeds to S103.

At S103, the presentation information adjusting section 140 executes the AD area approach notification. Specifically, the AD area approach messages N1h and N1m are displayed on the HUD 21 and the meter display 22.

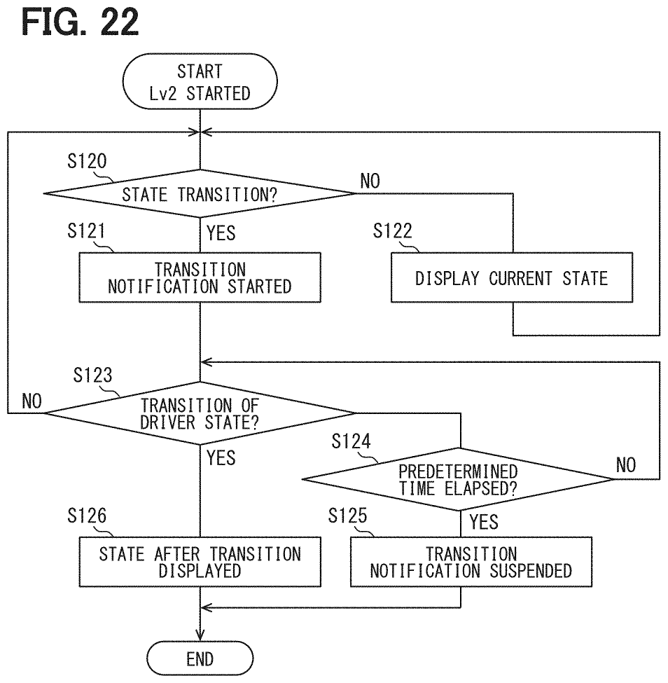

After S103, the procedure proceeds to S110 in FIG. 22. At S100, the surrounding state grasping section 110 assesses whether or not the vehicle A has entered the AD area. If it is assessed that the vehicle A has entered the AD area, the procedure proceeds to S111, and the AD area entrance notification is executed.

Next, at S112, the driving state determining section 120 assesses whether or not the driver has permitted Level 2 automated driving. If it is assessed that the driver has not permitted Level 2 automated driving, at S113, the presentation information adjusting section 140 assesses whether or not tolerated time has elapsed after the entrance into the AD area. If it is assessed that the tolerated time has not elapsed, the procedure returns to S112. On the other hand, if it is assessed that the tolerated time has elapsed, at S114, the presentation information adjusting section 140 stops the AD area entrance notification on the HUD 21 and the meter display 22, and additionally continues the AD area entrance notification on the CID 23, and the procedure returns to S112.

In a case that it is assess at S112 that the driver has permitted Level 2 automated driving, the procedure proceeds to S115. At S115, the presentation information adjusting section 140 executes the Level 2 start notification. After executing the process at S115, the series of processing ends.

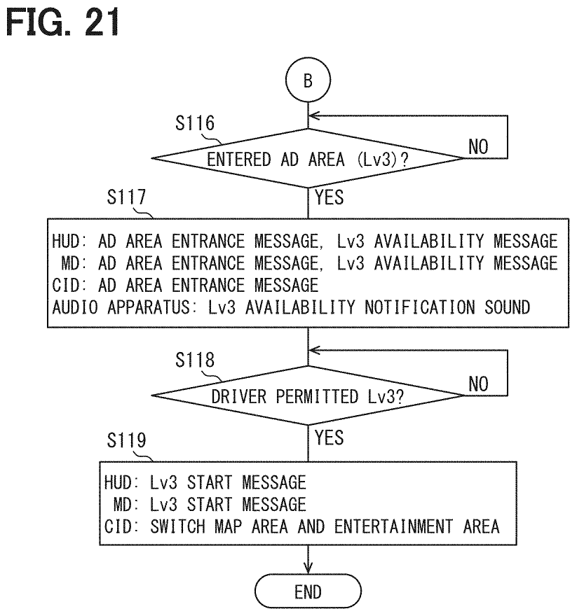

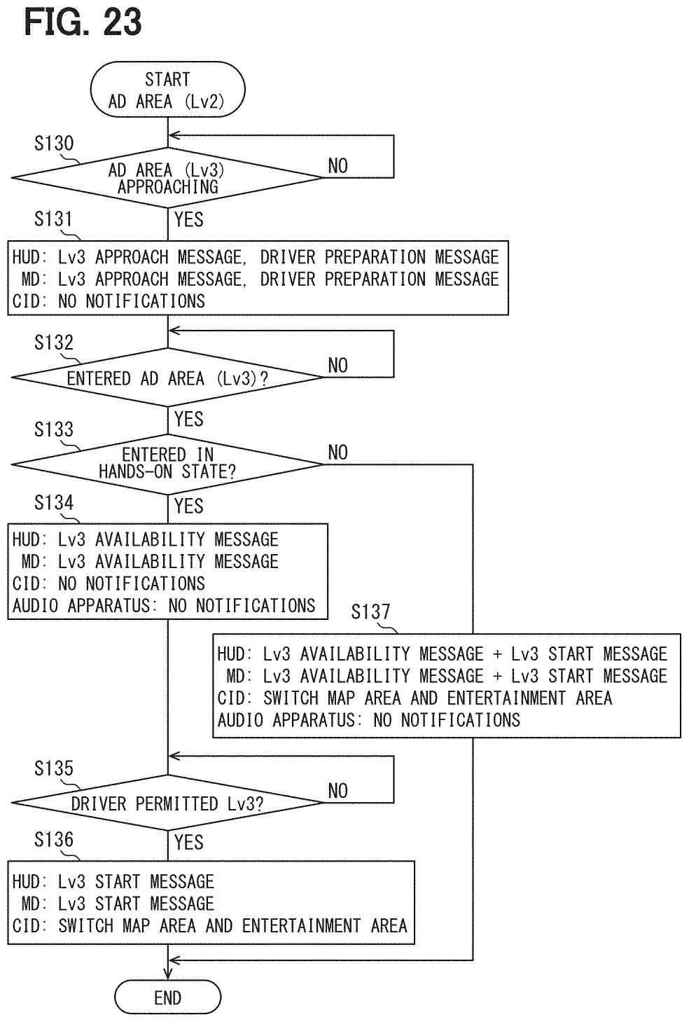

On the other hand, in a case that the surrounding state grasping section 110 assesses at S102 in FIG. 21 that Level 3 automated driving is available after entering the AD area, the procedure proceeds to S116 in FIG. 23. At S116, the surrounding state grasping section 110 assesses whether or not the vehicle A has entered the AD area. If it is assessed that the vehicle A has entered the AD area, the procedure proceeds to S117, and the presentation information adjusting section 140 executes the AD area entrance notification and the Level 3 availability notification. Next, at S118, the driving state determining section 120 assesses whether or not a Level 3 start instruction has been acquired from the driver. If it is assessed that a start instruction has been acquired, at S119, the presentation information adjusting section 140 executes the Level 3 start notification. After executing the process at S119, the series of processing ends.

Next, a procedure of a driver state presentation control method in Level 2 automated travelling is explained according to FIG. 22. First, at S120, the driving state determining section 120 assesses whether or not the states (the suspension permitted states and the suspension prohibited states) related to body parts of the driver have changed. If it is assessed that there are no changes, at S122, the display of the current state is maintained. On the other hand, if it is assessed that there is a transition of a state, at S121, the presentation information adjusting section 140 starts state transition notification.

Thereafter, at S123, the driver state estimating section 130 assesses whether or not the actual operational state of the driver has made a transition to a state corresponding to the applicable state. In a case that the transition has not been made, at S124, it is assessed whether or not predetermined time has elapsed since the start of the transition notification, and in a case that the predetermined time has not elapsed, the procedure returns to S123. In a case that it is assessed that the predetermined time has elapsed, at S125, the presentation information adjusting section 140 suspends the transition notification, and the series of processing ends. On the other hand, in a case that it is assessed at S123 that the transition has been made, the state after the transition is displayed, and the series of processing ends.

Next, a presentation control method in a case that there is a transition from Level 2 automated travelling to Level 3 automated travelling is explained with reference to a procedure in FIG. 23.

First, at S130, the surrounding state grasping section 110 assesses whether or not an ST segment is approaching. In a case that it is assessed that an ST segment is not approaching, the procedure waits until an ST segment approaches. If it is assessed that an ST segment is approaching, at S131, the presentation information adjusting section 140 executes the Level 3 approach notification and the driver preparation notification. Note that in a case that the driver preparation notification is not necessary, the driver preparation notification may be suspended.

After S131, the procedure proceeds to S132. At S132, the surrounding state grasping section 110 assesses whether or not the vehicle A has entered the ST segment. If it is assessed that the vehicle A has entered the ST segment, the procedure proceeds to S133, and the driving state determining section 120 assesses whether or not the vehicle A has entered the ST segment in a hands-on state.

In a case that it is assessed at S133 that the vehicle A has entered the ST segment in a hands-on state, the procedure proceeds to S134. At S134, the presentation information adjusting section 140 executes the Level 3 availability notification. Next, at S135, the driving state determining section 120 assesses whether or not the driver has given an instruction for Level 3 automated travelling control. If it is assessed that the driver has given the instruction, at S136, the presentation information adjusting section 140 executes the Level 3 start notification. After executing the process at S136, the series of processing ends.

On the other hand, in a case that it is assessed at S133 that the vehicle A has entered the ST segment in a hands-off state, the procedure proceeds to S137. At S137, the Level 3 availability notification and the Level 3 start notification are executed simultaneously, and the series of processing ends.

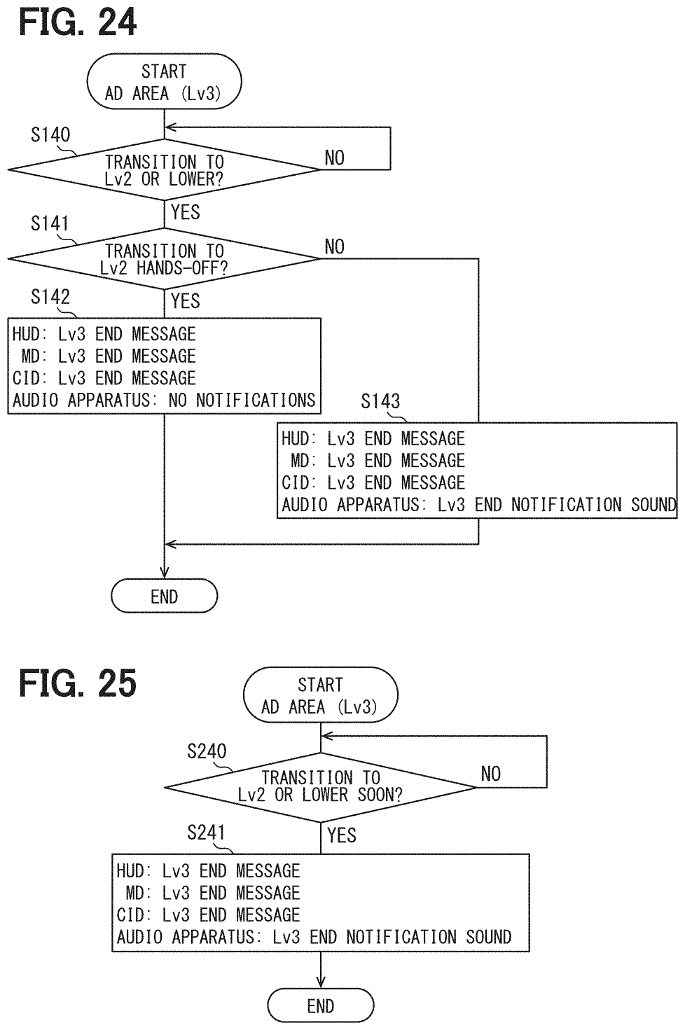

Next, a presentation control method in a case that the Level 3 automated travelling ends is explained with reference to a procedure in FIG. 24.

At S140, the driving state determining section 120 determines whether to or not to make a transition to travelling control of Level 2 or lower. If it is determined to make the transition, the procedure proceeds to S141, and the driving state determining section 120 determines whether to or not to make a transition to a Level 2 hands-off permitted state. If it is determined to make a transition to a Level 2 hands-off permitted state, the procedure proceeds to S142, and the presentation information adjusting section 140 executes the Level 3 end notification. Specifically, display of the Level 3 end message N7m on the display device is executed. After the execution of the process at S142, the series of processing ends.

On the other hand, if it is determined at S141 to make a transition to a state other than Level 2 hands-off, that is, any of Level 2 hands-on, Level 1 and level 0 (manual driving), the procedure proceeds to S143. At S143, the presentation information adjusting section 140 executes the Level 3 end notification. Specifically, in addition to the Level 3 end message N7m on the display device, Level 3 end notification sound output by the audio apparatus 24 is executed.

Note that S116 and S132 mentioned above are an example of a “judgment process,” and S117, S134 and S137 are an example of a “presentation control process.”

According to the first embodiment mentioned above, the first transition information related to a transition from the automated driving prohibited state to the particular action permitted state is presented in a presentation mode with a more emphasized manner than the second transition information related to a transition from the particular action prohibited state to the particular action permitted state. Therefore, the driver can more surely recognize a transition from the automated driving prohibited state to the particular action permitted state in which transition the driver needs to be more careful. Because of this, highly convenient information presentation can become possible.

### Second Embodiment

In the second embodiment, a modification example of the HCU 100 in the first embodiment is explained. In the second embodiment, in a case that there is a transition from a Level 3 permitted state to a Level 2 permitted state, the presentation information adjusting section 140 executes output of a transition notification sound by the audio apparatus 24 also in a transition to a hands-off permitted state. That is, the presentation information adjusting section 140 gives a notification by the display device in a case that there is a transition from a Level 2 permitted state to a Level 3 permitted state. Then, in a case that there is a transition from a Level 3 permitted state to a Level 2 permitted state, the presentation information adjusting section 140 gives a notification by the audio apparatus 24 in addition to notifications by the display devices.

Thereby, the presentation information adjusting section 140 presents information related to transitions in different presentation modes for a case that there is a transition (permission transition) from a state where second tasks are prohibited to a state where second tasks are permitted, and for a case that there is a transition (prohibition transition) from a state where second tasks are permitted to a state where second tasks are prohibited. In particular, in the present embodiment, information (prohibition transition information) related to a prohibition transition is presented in a more emphasized manner than information (permission transition information) related to a permission transition.

A procedure of a presentation control method executed by the HCU 100 in the second embodiment is explained below according to FIG. 25. A process at S240 is similar to the process at S140 in the first embodiment. In a case that it is determined to make a transition to traveling of Level 2 or lower at S240, at S241, the presentation information adjusting section 140 executes the Level 3 end notification. Specifically, in addition to display of the Level 3 end message on each display device, Level 3 end sound output by the audio apparatus 24 is executed. After the process at S241 is executed, the series of processing ends.

In the second embodiment, S132 and S240 mentioned above are an example of a “judgment process,” and S134, S137 and S241 are an example of a “presentation control process.”

According to the second embodiment mentioned above, prohibition transition information related to a transition from a particular action permitted state to a particular action prohibited state is presented in a presentation mode with a more emphasized manner than permission transition information related to a transition from a particular action prohibited state to a particular action permitted state. Therefore, the driver can more surely recognize a transition from the particular action permitted state to the particular action prohibited state in which transition the driver needs to be more careful. Because of this, highly convenient information presentation can become possible.

Note that instead of or in addition to the Level 3 end sound output, the presentation information adjusting section 140 may display the Level 3 end message in the prohibition transition in a mode with a more emphasized manner than it does for the Level 3 end message in the permission transition. For example, the presentation information adjusting section 140 may emphasize the Level 3 end message more than it does for the permission transition by changing the display color, size or the like of the Level 3 end message.

### Third Embodiment

In the third embodiment, a modification example of the HCU 100 in the first embodiment is explained. In the third embodiment, the second automated driving ECU 70 makes a transition to automated travelling of Level 3 or higher in a case that Level 2 hands-off is permitted, and additionally there is not an override by the driver, that is, the driver state is actually a hands-off state.

In this case, in a case that it is determined that the driver state is a hands-on state in a hands-off permitted state, the presentation information adjusting section 140 executes transition unavailability notification of notifying that it is not possible to make a transition to automated travelling of Level 3 or higher. For example, in the transition unavailability notification, message images are displayed on the HUD 21 and the meter display 22. The message images may be ones with a text directly representing that the transition is not allowed, or may be ones indirectly representing that the transition is not allowed by a text representing that transition to Level 3 is allowed if the driver state becomes a hands-off state.

Note that even if the driver performs steering operation when the driver state is a Level 2 hands-off state, the Level 2 hands-off state is maintained until a predetermined torque amount. On the other hand, in a case that the torque amount is equal to or higher than the predetermined torque amount, the driver state is an override state.

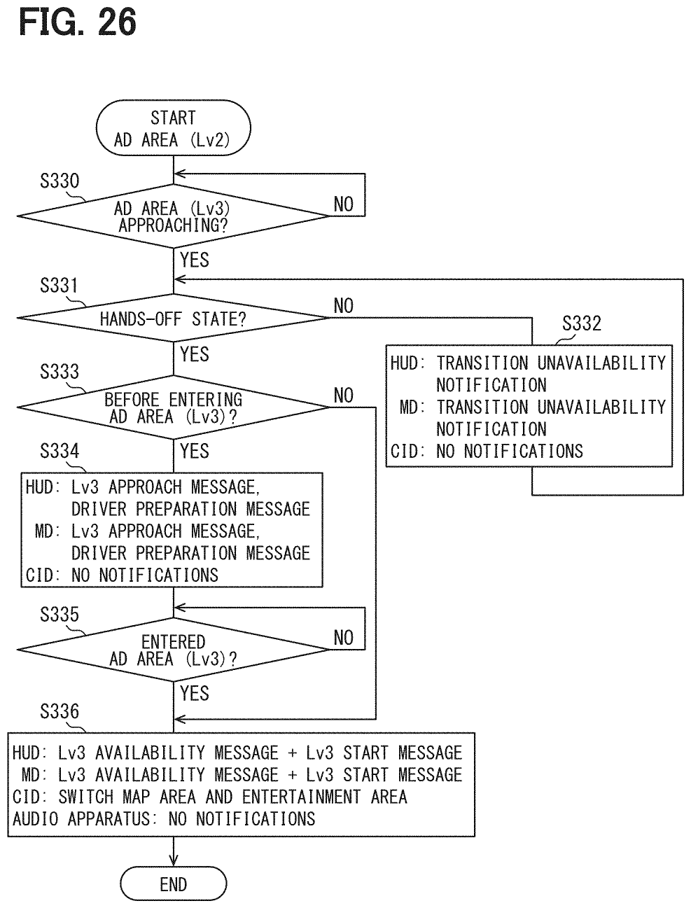

A procedure of a presentation control method executed by the HCU 100 in the third embodiment is explained below according to FIG. 26. A process at S330 is similar to the process at S130 in the first embodiment. In a case that it is assessed at S330 that an ST segment is approaching, at S331, the driver state estimating section 130 assesses whether or not the current driver state is a hands-off state. If it is assessed that the driver state is not a hands-off state (is a hands-on state), at S332, the presentation information adjusting section 140 executes the transition unavailability notification.

On the other hand, if it is assessed at S331 that the driver state is a hands-off state, at S333, the surrounding state grasping section 110 assesses whether or not the vehicle A has not entered an ST segment at a timing when the driver state has become a hands-off state. If it is assessed that the vehicle A has not entered an ST segment, the procedure proceeds to S334. S334 is similar to the process at S131. At S335, the surrounding state grasping section 110 assesses whether or not the vehicle A has entered an ST segment. If it is assessed that the vehicle A has entered an ST segment, the procedure proceeds to S336. S336 is similar to the process at S137. On the other hand, if it is assessed at S333 that the vehicle A has already entered an ST segment at a timing when the driver state has become a hands-off state, S334 and S335 are skipped, and the procedure proceeds to S336. After executing the process at S336, the series of processing ends.

Note that whereas the presentation information adjusting section 140 presents the transition unavailability notification since before entrance into an ST segment in the present embodiment, the transition unavailability notification may be presented after entrance into an ST segment, in other possible configuration. In addition, in the present embodiment, the presentation information adjusting section 140 presents the transition unavailability notification if the driver state has not become a hands-off state in a state that an ST segment is approaching. Instead of this the presentation information adjusting section 140 may be configured to present the transition unavailability notification if the driver state is a hands-on state in a hands-off permitted state, irrespective of whether or not an ST segment is approaching.

### Fourth Embodiment

In the Level 3 end notification in the embodiments mentioned above, the presentation information adjusting section 140 causes the audio apparatus 24 to present the Level 3 availability notification sound in a case that there is the first transition, to thereby present, to the driver, the information related to the first transition in a more emphasized manner than it does for the information related to the second transition. Instead of this, the presentation information adjusting section 140 may cause the Level 3 availability messages N5h and N5m to be displayed on the display devices in the first transition in a display mode with a more emphasized manner than it does for the second transition, to thereby emphasize the information related to the first transition more than it does for the information related to the second transition. For example, the presentation information adjusting section 140 may emphasize the Level 3 availability messages N5h and N5m than in the second transition by changing the display color, size or the like of the Level 3 availability messages N5h and N5m.

### Fifth Embodiment

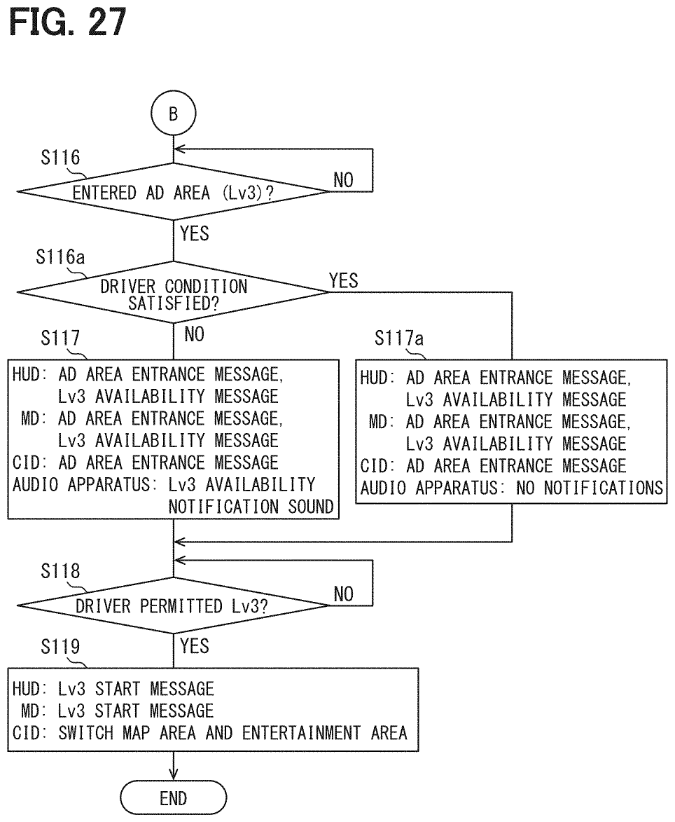

In a fifth embodiment, a modification example of the HCU 100 in the first embodiment is explained. Constituent elements in FIG. 27 that are given reference characters identical to those in the figures of the first embodiment are similar constituent elements, and attain similar effects and advantages.

In the fifth embodiment, in a case that the driver state estimating section 130 assesses that the driver condition of the driver for implementing Level 3 is not satisfied, the presentation information adjusting section 140 stops emphasizing the information related to the first transition in the Level 3 availability notification. Specifically, the presentation information adjusting section 140 prohibits presentation of the Level 3 availability notification sound by the audio apparatus 24. Thereby, the Level 3 availability notification in a case that the driver condition is satisfied is given in substantially the same modes for a case that there is a transition from the automated driving prohibited state to the Level 3 available state, and for a case that there is a transition from the Level 2 available state to the Level 3 available state. In the fifth embodiment, the driver state estimating section 130 is an example of a “preparation assessing section.” Satisfying the driver condition is equivalent to being able to prepare for execution of automated driving in which particular actions are permitted.

A process executed by the HCU 100 in the fifth embodiment is explained with reference to a procedure in FIG. 27. In a case that it is assessed at S116 that the vehicle A has entered an AD area, this procedure proceeds to S116a. At S116a, the driver state estimating section 130 assesses whether or not the driver condition is satisfied. If it is assessed that the driver condition is not satisfied, this procedure proceeds to S117. That is, at S117, the AD area entrance notification and the Level 3 availability notification with emphasis are executed.

On the other hand, if it is assessed that the driver condition is satisfied, this procedure proceeds to S117a. At S117a, the presentation information adjusting section 140 executes the AD area entrance notification and the Level 3 availability notification without emphasis. That is, at S117a, the notification by the audio apparatus 24 is not executed in the Level 3 availability notification.

According to the fifth embodiment mentioned above, in a case that it is assessed that preparation by the driver for automated driving has been done, presentation of the first transition information in a presentation mode with an emphasized manner is stopped. Therefore, only in a case that preparation by the driver for automated driving has not been done, transition information can be presented in an emphasized manner. Accordingly, it can become possible to use information presentation modes more appropriately on a case-by-case basis.

### Sixth Embodiment

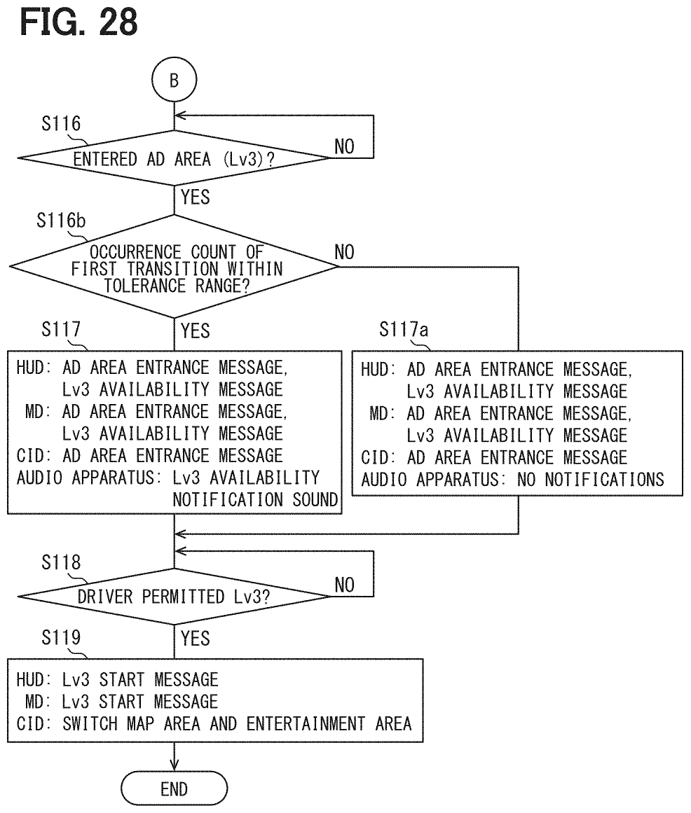

In a sixth embodiment, a modification example of the HCU 100 in the first embodiment is explained. Constituent elements in FIG. 28 that are given reference characters identical to those in the figures of the first embodiment are similar constituent elements, and attain similar effects and advantages.

In the sixth embodiment, in a case that the occurrence count (the number of times of transitions) of the first transition in a predetermined period becomes greater than a tolerance range, the presentation information adjusting section 140 stops emphasizing the information related to the first transition when and after the occurrence count becomes greater than the tolerance range. Stopping emphasizing is equivalent to relatively reducing the degree of emphasis than in a case that the occurrence count of the first transition is not greater than the tolerance range. Here, the predetermined period may be a period from the start of travelling of the vehicle A until a stop of the travelling or may be a period until the vehicle A travels a predetermined threshold distance or for threshold time. In addition, the tolerance range here is defined as a numerical range equal to or smaller than a threshold number of times or smaller than a threshold number of times. For example, the tolerance range of the occurrence count is one.

Specifically, the presentation information adjusting section 140 prohibits presentation of the Level 3 availability notification sound by the audio apparatus 24 as an emphasis stopping process. That is, the Level 3 availability notification in the first transition at and after the second time in the predetermined period is a mode substantially the same as a case of the second transition.

A process executed by the HCU 100 in the sixth embodiment is explained with reference to a procedure in FIG. 28. In a case that it is assessed at S116 that the vehicle A has entered an AD area, this procedure proceeds to S116b. At S116b, the presentation information adjusting section 140 assesses whether or not the occurrence count of the first transition is within a tolerance range. If it is assessed that the occurrence count is within the tolerance range, this procedure proceeds to S117. That is, at S117, the AD area entrance notification and the Level 3 availability notification with emphasis are executed.

On the other hand, if it is assessed that the occurrence count of the first transition is greater than the tolerance range, this procedure proceeds to S117a. At S117a, the presentation information adjusting section 140 executes the AD area entrance notification and the Level 3 availability notification without emphasis. That is, at S117a, the notification by the audio apparatus 24 is not executed in the Level 3 availability notification.

According to the sixth embodiment mentioned above, in a case that it is determined the occurrence count of the first transition in a predetermined period is greater than the tolerance range, the degree of emphasis of the first transition information is relatively lowered as compared to a case that the occurrence count is within the tolerance range. Therefore, only when the occurrence count of the first transition is relatively small, the transition information can be presented in an emphasized manner. Accordingly, it can become possible to use information presentation modes more appropriately on a case-by-case basis.

### Seventh Embodiment

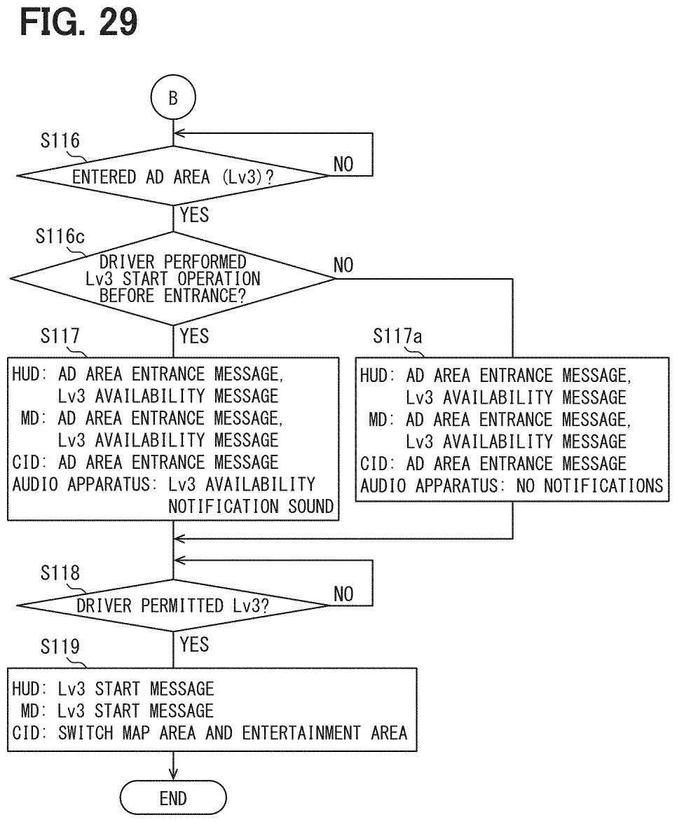

In a seventh embodiment, a modification example of the HCU 100 in the first embodiment is explained. Constituent elements in FIG. 29 that are given reference characters identical to those in the figures of the first embodiment are similar constituent elements, and attain similar effects and advantages.

In the seventh embodiment, the presentation information adjusting section 140 assesses whether or not the driver has executed automated driving Level 3 start operation before the vehicle A enters an ST segment which is an AD area where automated driving Level 3 is available. In a case that it is assessed that the driver has executed automated driving Level 3 start operation, the presentation information adjusting section 140 executes emphasis of the information related to the first transition. On the other hand, in a case that it is assessed that the driver has not executed automated driving Level 3 start operation before the vehicle A enters the ST segment, the presentation information adjusting section 140 stops emphasizing the information related to the first transition. That is, in a case that the driver has executed the automated driving Level 3 start operation before the vehicle A enters an AD area where automated driving Level 3 is available, the presentation information adjusting section 140 executes emphasis of the information related to the first transition. Executing the start operation before the vehicle A enters the AD area where automated driving Level 3 is available is equivalent to executing the start operation before a transition to a particular action permitted state.

A process executed by the HCU 100 in the seventh embodiment is explained with reference to a procedure in FIG. 29. In a case that it is assessed at S116 that the vehicle A has entered an AD area, this procedure proceeds to S116c. At S116c, the presentation information adjusting section 140 assesses whether or not the driver has executed automated driving Level 3 start operation before the vehicle A enters an AD area where automated driving Level 3 is available. If it is assessed that the driver has executed automated driving Level 3 start operation, this procedure proceeds to S117. That is, at S117, the AD area entrance notification and the Level 3 availability notification with emphasis are executed.

On the other hand, if it is assessed that the driver has not executed automated driving Level 3 start operation before the vehicle A enters the AD area where automated driving Level 3 is available, this procedure proceeds to S117a. At S117a, the presentation information adjusting section 140 executes the AD area entrance notification and the Level 3 availability notification without emphasis. That is, at S117a, the notification by the audio apparatus 24 is not executed in the Level 3 availability notification.

According to the sixth embodiment mentioned above, if it is assessed that the driver has not executed automated driving Level 3 start operation before the vehicle A enters an AD area where automated driving Level 3 is available, the degree of emphasis of the first transition information is relatively lowered as compared to a case that it is assessed that the driver has executed automated driving Level 3 start operation. Therefore, only in a case that automated driving Level 3 start operation has been executed before the vehicle A enters an AD area where automated driving Level 3 is available, the transition information can be presented in an emphasized manner. Accordingly, in a case that there is a time lag between a time point when automated driving Level 3 start operation is performed and a time point when it becomes actually possible to execute automated driving Level 3, the driver can be notified more surely that it has become possible to execute automated driving Level 3.

### Eighth Embodiment

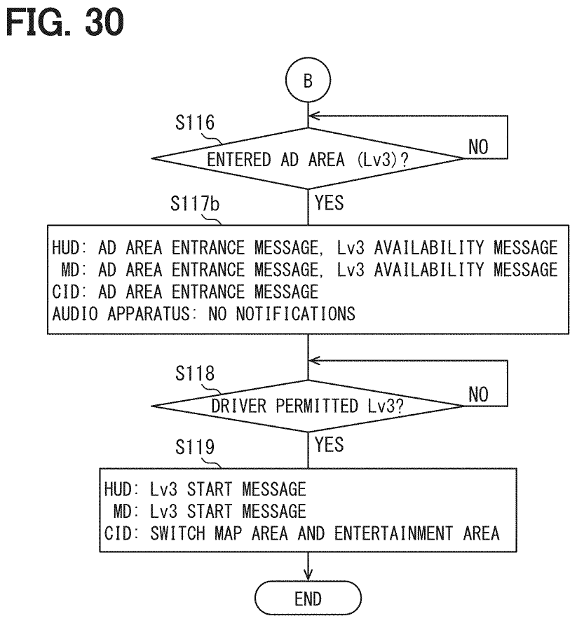

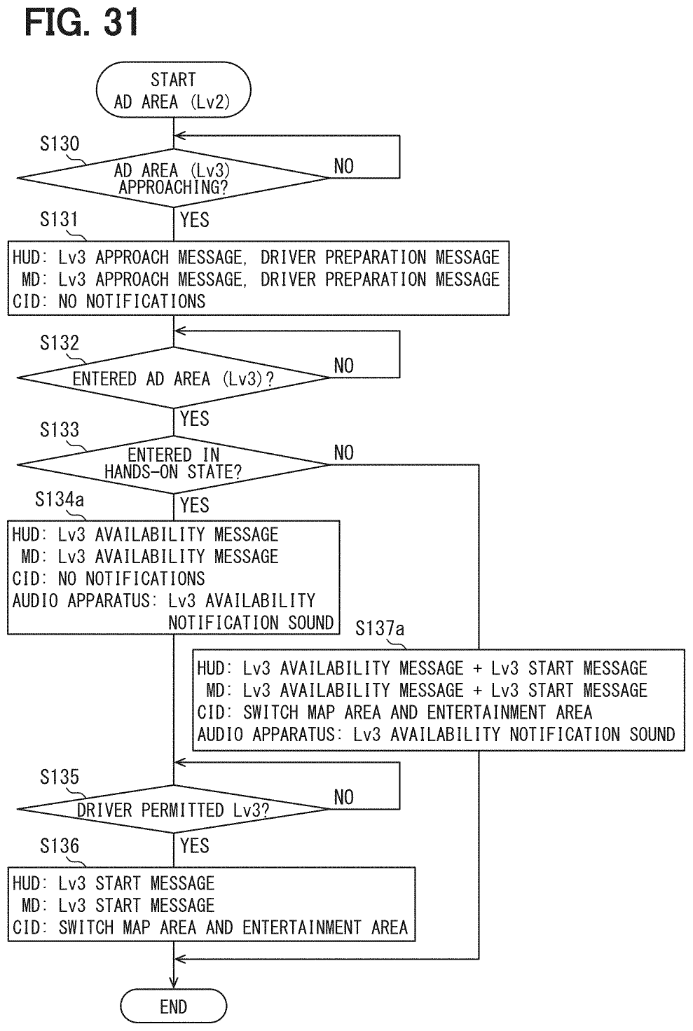

In an eighth embodiment, a modification example of the HCU 100 in the first embodiment is explained. Constituent elements in FIGS. 30 and 31 that are given reference characters identical to those in the figures of the first embodiment are similar constituent elements, and attain similar effects and advantages.

In the eighth embodiment, the presentation information adjusting section 140 presents, to the driver, the information related to the second transition in a more emphasized manner than it does for the information related to the first transition. Specifically, the presentation information adjusting section 140 emphasizes the Level 3 availability notification in the second transition more than it does for the Level 3 availability notification in the first transition. For example, the presentation information adjusting section 140 presents the Level 3 availability notification sound by the audio apparatus 24 in the Level 3 availability notification in the second transition, and may stop the presentation in the Level 3 availability notification in the first transition. Note that the presentation information adjusting section 140 may cause the Level 3 availability messages N5h and N5m to be displayed on the display devices in the second transition in a display mode with a more emphasized manner than in the first transition, to thereby emphasize the information related to the second transition more than it does for the information related to the first transition.

A process executed by the HCU 100 in the eighth embodiment is explained with reference to a procedure in FIGS. 30 and 31. In a case that it is assessed at S116 in FIG. 30 that the vehicle A has entered an AD area, this procedure proceeds to S117b. At S117b, the presentation information adjusting section 140 executes the AD area entrance notification and the Level 3 availability notification with emphasis. That is, at S117b, the Level 3 availability notification by the audio apparatus 24 is not executed. After the process at S117b, this procedure proceeds to S118.

In a case that it is assessed at S133 in FIG. 31 that the vehicle A has entered the ST segment in a hands-on state, the procedure proceeds to S134a. At S134a, the presentation information adjusting section 140 executes the emphasized Level 3 availability notification. After the process at S134a is executed, this procedure proceeds to S135.

On the other hand, in a case that it is assessed at S133 that the vehicle A has entered the ST segment in a hands-off state, the procedure proceeds to S137a. At S137a, the emphasized Level 3 availability notification and the Level 3 start notification are executed simultaneously, and the series of processing ends.

According to the eighth embodiment mentioned above, the second transition information related to a transition from a particular action prohibited state to a particular action permitted state is presented in a presentation mode with a more emphasized manner than the first transition information related to a transition from an automated driving prohibited state to a particular action permitted state. Therefore, the driver can more surely recognize a transition from the automated driving prohibited state to the particular action permitted state in which transition the driver needs to be more careful. Because of this, highly convenient information presentation can become possible.

### Ninth Embodiment

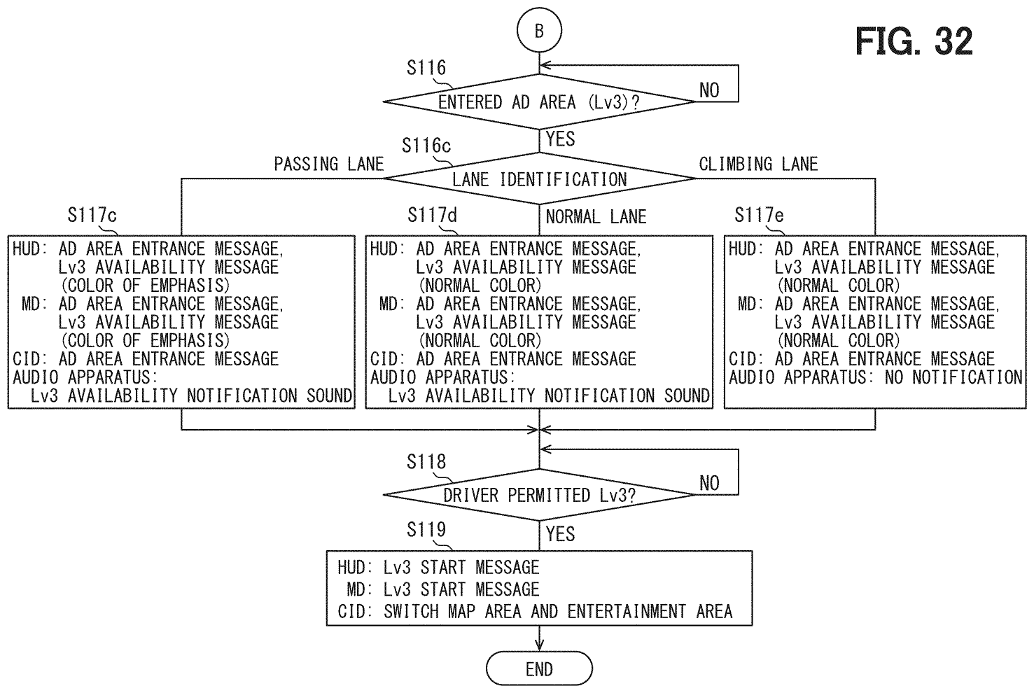

In a ninth embodiment, a modification example of the HCU 100 in the first embodiment is explained. Constituent elements in FIG. 32 to FIG. 34 that are given reference characters identical to those in the figures of the first embodiment are similar constituent elements, and attain similar effects and advantages.

In the ninth embodiment, the surrounding state grasping section 110 judges the type of lane where the vehicle A is currently travelling. For example, the surrounding state grasping section 110 judges whether the lane where the vehicle A is travelling is a passing lane, a climbing lane or a normal lane other than them. The surrounding state grasping section 110 is an example of a “lane identifying section.”

In accordance with the judged type of lane, the presentation information adjusting section 140 changes the degrees of emphasis of the presentation modes of the first transition information and the second transition information. Specifically, the presentation information adjusting section 140 uses different degrees of emphasis of the Level 3 availability notification for a case that the current lane is a passing lane, a case that the current lane is a normal lane and a case that the current lane is a climbing lane. For example, the presentation information adjusting section 140 emphasizes the transition information for a lane where it is allowed by traffic laws to pass or drive faster than a non-user's vehicle travelling on a predetermined lane, more than it does for the predetermined lane. As an example, the presentation information adjusting section 140 presents the Level 3 availability notification for climbing lanes, normal lanes and passing lanes with degrees of emphasis which increase in this order.

As an example of changes of the degrees of emphasis, in a case that the Level 3 availability notification is executed when the vehicle A is travelling on a climbing lane, the presentation information adjusting section 140 displays the Level 3 availability messages in a normal color, and additionally does not execute presentation of the Level 3 availability notification sound by the audio apparatus 24. Here, the normal color is a color which is not noticeable (e.g. white, blue, etc.) as compared to a color of emphasis mentioned later. Then, in a case that the Level 3 availability notification is executed when the vehicle A is travelling on a normal lane, the presentation information adjusting section 140 displays the Level 3 availability message in the normal color, and additionally executes presentation of the Level 3 availability notification sound by the audio apparatus 24. Additionally, in a case that the Level 3 availability notification is executed when the vehicle A is travelling on a passing lane, the presentation information adjusting section 140 displays the Level 3 availability message in the color of emphasis (e.g. an alarming color such as red or yellow), and additionally executes presentation of the Level 3 availability notification sound by the audio apparatus 24.

A process executed by the HCU 100 in the ninth embodiment is explained with reference to a procedure in FIGS. 32 to 34. First, in a case that it is assessed at S116 in FIG. 32 that the vehicle A has entered an AD area, this procedure proceeds to S116c. At S116c, the surrounding state grasping section 110 judges the type of lane where the vehicle A is currently travelling.

If it is assessed at S116c that the vehicle A is travelling on a passing lane, this procedure proceeds to S117c. At S117c, the presentation information adjusting section 140 executes the AD area entrance notification and the Level 3 availability notification in a presentation mode with a more emphasized manner than in a case that the vehicle A is travelling on a normal lane or a climbing lane.

In addition, if it is assessed at S116c that the vehicle A is travelling on a normal lane, this procedure proceeds to S117d. At S117d, the presentation information adjusting section 140 executes the AD area entrance notification and the Level 3 availability notification in a presentation mode with a higher degree of emphasis than in a case that the vehicle A is travelling on a climbing lane and with a lower degree of emphasis than in a case that the vehicle A is travelling on a passing lane.

Furthermore, if it is assessed at S116c that the vehicle A is travelling on a climbing lane, this procedure proceeds to S117e. At S117e, the presentation information adjusting section 140 executes the AD area entrance notification and the Level 3 availability notification in a presentation mode with a lower degree of emphasis than in a case that the vehicle A is travelling on a normal lane or a climbing lane.

If the process of any of S117c, S117d and S117e is executed, this procedure proceeds to S118. Note that S116c, S133a and S133c mentioned above are an example of a “lane identification process.” In addition, S117c, S117d, S117e, S134c, S134d, S134e, S137c, S137d and S137e mentioned above are an example of a “presentation control process.”

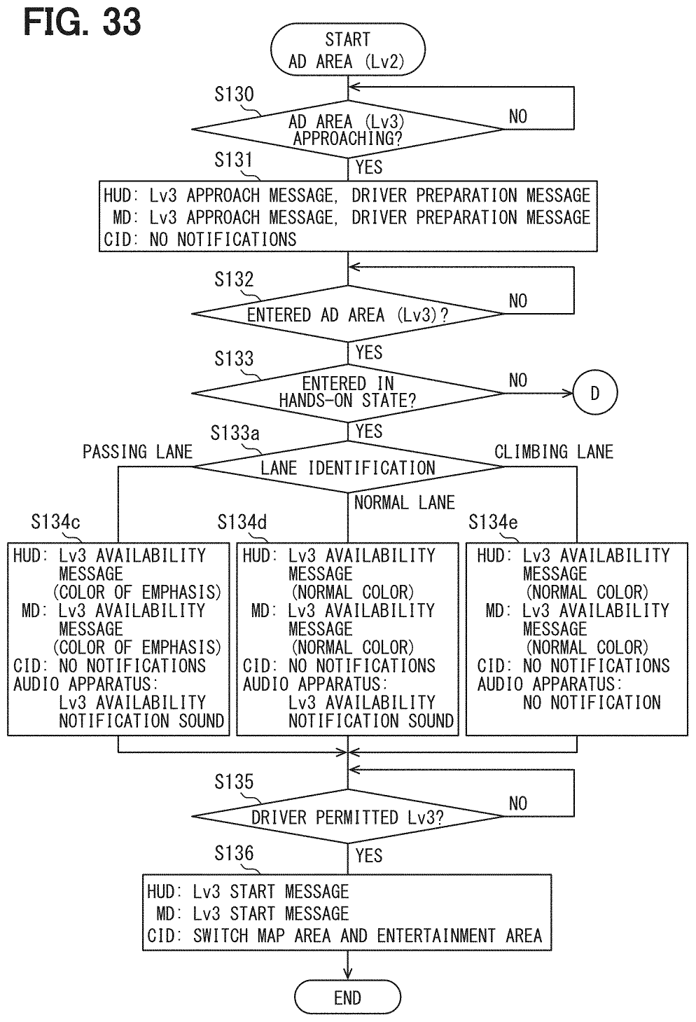

Next, a flowchart in FIG. 33 is explained. In a case that it is assessed at S133 in FIG. 33 that the vehicle A has entered an AD area in a hands-on state, the procedure proceeds to S133a. At S133a, the surrounding state grasping section 110 judges the type of lane where the vehicle A is currently travelling.

If it is assessed at S133a that the vehicle A is travelling on a passing lane, this procedure proceeds to S134c. At S134c, the presentation information adjusting section 140 executes the Level 3 availability notification in a presentation mode with a more emphasized manner than in a case that the vehicle A is travelling on a normal lane or a climbing lane.

In addition, if it is assessed at S133a that the vehicle A is travelling on a normal lane, this procedure proceeds to S134d. At S134d, the presentation information adjusting section 140 executes the Level 3 availability notification in a presentation mode with a higher degree of emphasis than in a case that the vehicle A is travelling on a climbing lane and additionally with a lower degree of emphasis than in a case that the vehicle A is travelling on a passing lane.

Then, if it is assessed at S133a that the vehicle A is travelling on a climbing lane, this procedure proceeds to S134e. At S134e, the presentation information adjusting section 140 executes the Level 3 availability notification in a presentation mode with a lower degree of emphasis than in a case that the vehicle A is travelling on a normal lane or a climbing lane.

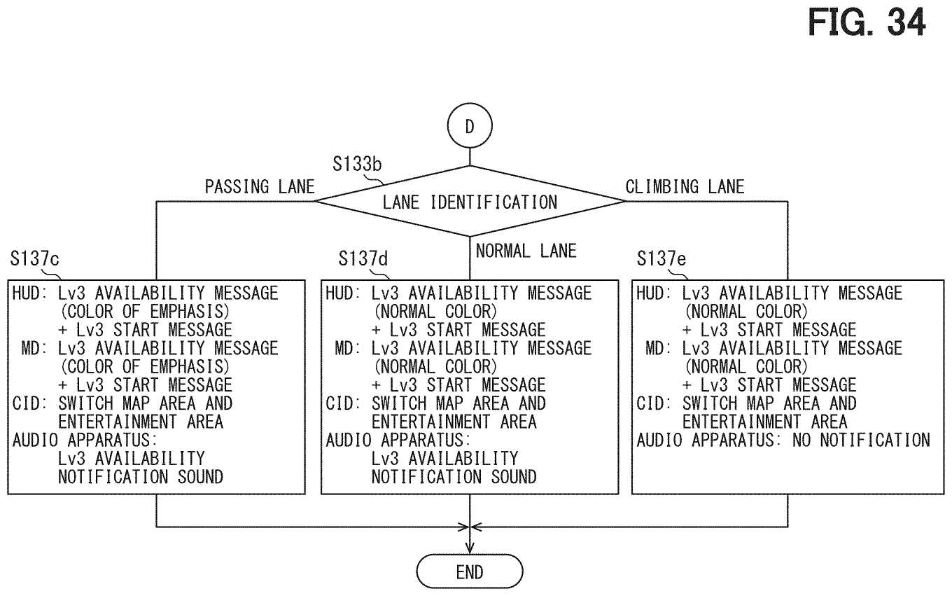

In addition, in a case that it is assessed at S133 that the driver state is not a hands-on state, the procedure proceeds to S133b in FIG. 34. Similarly to S133a, at S133b, the surrounding state grasping section 110 judges the type of lane where the vehicle A is currently travelling.

If it is assessed at S133b that the vehicle A is travelling on a passing lane, this procedure proceeds to S137c. At S137c, the presentation information adjusting section 140 executes the Level 3 start notification and the Level 3 availability notification in a presentation mode with a more emphasized manner than in a case that the vehicle A is travelling on a normal lane or a climbing lane.

In addition, if it is assessed at S133b that the vehicle A is travelling on a normal lane, this procedure proceeds to S137d. At S137d, the presentation information adjusting section 140 executes the Level 3 start notification and the Level 3 availability notification in a presentation mode with a higher degree of emphasis than in a case that the vehicle A is travelling on a climbing lane and additionally with a lower degree of emphasis than in a case that the vehicle A is travelling on a passing lane.

Then, if it is assessed at S133b that the vehicle A is travelling on a climbing lane, this procedure proceeds to S137e. At S137e, the presentation information adjusting section 140 executes the Level 3 start notification and the Level 3 availability notification in a presentation mode with a lower degree of emphasis than in a case that the vehicle A is travelling on a normal lane or a climbing lane.

According to the ninth embodiment mentioned above, the degrees of emphasis of the presentation modes of the first transition information related to a transition from an automated driving prohibited state to a particular action permitted state and the second transition information related to a transition from a particular action prohibited state to a particular action permitted state are changed in accordance with the type of lane where the vehicle A is travelling. Therefore, it is possible to cause the driver to recognize each piece of information with a degree of emphasis according to a lane where the vehicle A is travelling. Because of this, highly convenient information presentation can become possible.

### Other Embodiments

The disclosure in this specification is not limited to embodiments depicted as examples. The disclosure incorporates embodiments depicted as examples, and aspects that are attained by modifications by those skilled in the art based on the embodiments. For example, the disclosure is not limited to combinations of components and/or elements depicted in the embodiments. The disclosure can be implemented by various combinations. The disclosure can have additional portions that can be added to the embodiments. The disclosure incorporates those from which components and/or elements of the embodiments are omitted. The disclosure incorporates those attained by replacement or combination of components and/or elements between one embodiment and another embodiment. Disclosed technical scopes are not limited by the description of the embodiments. Several technical scopes disclosed should be understood as including all changes in meanings and the scope depicted by the description of claims and furthermore equivalent to the description of the claims.

Whereas the presentation information adjusting section 140 presents auditory information by the audio apparatus 24 as information in a particular mode different from that of visual information in the embodiments mentioned above, the information in the particular mode is not limited to this. For example, the presentation information adjusting section 140 may be configured to present tactile information. Specifically, the presentation information adjusting section 140 presents tactile information by vibrating a vibration member provided to a seat on which the driver is seated, the steering wheel, a seat belt apparatus or the like. Note that the presentation information adjusting section 140 may emphasize information presentation by presenting both auditory information and tactile information. In addition, the presentation information adjusting section 140 may combine visual information in a display mode with an emphasized manner and auditory information and/or tactile information. Alternatively, the presentation information adjusting section 140 may emphasize information presentation by increasing the number of times of notification. Alternatively, the presentation information adjusting section 140 may emphasize information presentation by increasing the amount of information to be presented.

In the sixth embodiment mentioned above, in a case that the occurrence count of the first transition in a predetermined period becomes greater than a tolerance range, the presentation information adjusting section 140 stops emphasizing the information related to the first transition when and after the occurrence count becomes greater than the tolerance range. Instead of this or in addition to this, in a case that the occurrence count of the second transition in the predetermined period becomes greater than the tolerance range, the presentation information adjusting section 140 may relatively lower the degree of emphasis of the information related to the second transition when and after the occurrence count becomes greater than the tolerance range.

In the ninth embodiment mentioned above, the presentation information adjusting section 140 changes the degree of emphasis of each piece of transition information in accordance with the applicable type of lane where the vehicle A is travelling, a passing lane, a climbing lane or a normal lane. Instead of this, the presentation information adjusting section 140 may be configured to change the degree of emphasis of each piece of transition information in accordance with the applicable type of lane where the vehicle A is travelling, a local road lane or a freeway lane. In this case, the presentation information adjusting section 140 may increase the degree of emphasis of each piece of transition information in a case that the vehicle A is travelling on a freeway lane than in a case that the vehicle A is travelling on a local road lane. That is, the presentation information adjusting section 140 may increase the degree of emphasis of each piece of transition information as a travelling speed tolerated for a lane on which the vehicle A is travelling increases.

Whereas the particular action permitted state is mainly explained as a state where automated driving Level 3 is permitted in the embodiments mentioned above, the particular action permitted state may be a state where automated driving Level 4 or higher is permitted. In addition, whereas the particular action prohibited state is explained as a state where automated driving Level 2 is permitted, the particular action permitted state may be a state where automated driving Level 1 is permitted.

The HCU 100 may be a dedicated computer including, as a processor, at least one of a digital circuit and an analog circuit. Here, specifically, the digital circuit is at least one type selected from an ASIC (Application Specific Integrated Circuit), an FPGA (Field Programmable Gate Array), an SOC (System on a Chip), a PGA (Programmable Gate Array), a CPLD (Complex Programmable Logic Device) and the like, for example. In addition, such a digital circuit may include a memory onto which a program is loaded.

The HCU 100 can be provided by one computer or a set of computer resources linked by data communication apparatuses. For example, some of functionalities provided by the HCU 100 in the embodiments mentioned above may be realized by another ECU.

What is claimed is:

1. A presentation control apparatus configured to control information presentation to a driver of a vehicle capable of performing automated driving, the presentation control apparatus comprising:
a judging section configured to distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited; and
a presentation control section configured to present first transition information related to a transition from the automated driving prohibited state to the particular action permitted state in an emphasized form compared to second transition information related to a transition from the particular action prohibited state to the particular action permitted state.

2. The presentation control apparatus according to claim 1, wherein
the presentation control section is configured to present the second transition information as visual information, and the first transition information as visual information and information in a particular form other than the visual information.

3. The presentation control apparatus according to claim 1, wherein
the presentation control section is configured to present the second transition information as visual information, and the first transition information as emphasized visual information compared to the second transition information.

4. The presentation control apparatus according to claim 1, further comprising:
a preparation assessing section configured to determine whether the driver prepared for the automated driving in which the driver is permitted to take the particular action in the particular action permitted state, wherein
the presentation control section is configured to stop presenting the first transition information in the emphasized form when it is determined that the driver prepared for the automated driving.

5. The presentation control apparatus according to claim 1, wherein
the presentation control section is configured to control an emphasis degree of the first transition information to be lower when it is determined that a number of a transition from the automated driving prohibited state to the particular action permitted state in a predetermined period is outside an acceptable range than when it is determined that the number of the transition is within the acceptable range.

6. The presentation control apparatus according to claim 1, wherein
the presentation control section is configured to control an emphasis degree of the first transition information to be lower when the presentation control section acquired a start operation of the automated driving in which the driver is permitted to take the particular action after the state is transitioned to the particular action permitted state than when the presentation control section acquired the start operation before the state is transitioned to the particular action permitted state.

7. A presentation control apparatus configured to control information presentation to a driver of a vehicle capable of performing automated driving, the presentation control apparatus comprising:
a judging section configured to distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited; and
a presentation control section configured to present second transition information related to a transition from the particular action prohibited state to the particular action permitted state in an emphasized form compared to first transition information related to a transition from the automated driving prohibited state to the particular action permitted state.

8. The presentation control apparatus according to claim 7, wherein
the presentation control section is configured to present the first transition information as visual information, and the second transition information as visual information and information in a particular form other than the visual information.

9. The presentation control apparatus according to claim 7, wherein
the presentation control section is configured to present the first transition information as visual information, and the second transition information as emphasized visual information compared to the first transition information.

10. The presentation control apparatus according to claim 1, wherein
the judging section is configured to distinguish, in the particular action prohibited state, a hands-off permitted state where the driver is permitted to release hands from a steering wheel and a hands-off prohibited state where the driver is prohibited to release the hands from the steering wheel, and
the presentation control section is configured to present third transition information related to a transition from the particular action permitted state to the automated driving prohibited state or to the hands-off prohibited state in an emphasized form compared to fourth transition information related to a transition from the particular action permitted state to the hands-off permitted state.

11. A presentation control apparatus configured to control information presentation to a driver of a vehicle capable of performing automated driving, the presentation control apparatus comprising:
a judging section configured to distinguish between a particular action permitted state where the driver is permitted to take a particular action other than driving during the automated driving and a particular action prohibited state where the driver is prohibited to take the particular action during the automated driving; and
a presentation control section configured to present prohibited transition information related to a transition from the particular action permitted state to the particular action prohibited state in an emphasized form compared to permitted transition information related to a transition from the particular action prohibited state to the particular action permitted state.

12. The presentation control apparatus according to claim 11, wherein
the presentation control section is configured to present the permitted transition information as visual information, and the prohibited transition information as visual information and information in a particular form other than the visual information.

13. The presentation control apparatus according to claim 11, wherein
the presentation control section is configured to present the permitted transition information as visual information, and the prohibited transition information as emphasized visual information compared to the second transition information.

14. A presentation control apparatus configured to control information presentation to a driver of a vehicle capable of performing automated driving, the presentation control apparatus comprising:
a judging section configured to distinguish between a particular action permitted state where the driver is permitted to take a particular action other than driving during the automated driving, a particular action prohibited state where the driver is prohibited to take the particular action during the automated driving, and an automated driving prohibited state where the automated driving is prohibited;
a lane identifying section configured to identify a type of a lane in which the vehicle is traveling, and
a presentation control section configured to present first information related to a transition from the automated driving prohibited state to the particular action permitted state and second information related to a transition from the particular action prohibited state to the particular action permitted state, wherein
the presentation control section is configured to change an emphasized degree of a presentation form of the first transition information and the second transition information depending on the type of the lane.
